(19) United States
(12) Patent Application Publication
(10) Pub. No.: US 2008/0038568 A1
(43) Pub. Date: Feb. 14, 2008

(54) Method for Producting Synthetic Resin Film and Synthetic Resin Film

(75) Inventors: Kan Fujihara, Shiga (JP); Kazuhiro Ono, Shiga (JP); Toshihisa Itoh, Kyoto (JP); Takaaki Matsuwaki, Shizuoka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KANEKA CORPORATION, Osaka-shi (JP)

(21) Appl. No.: 10/590,821

(22) PCT Filed: Feb. 21, 2005
(86) PCT No.: PCT/JP05/03240

§ 371 Date: Jun. 8, 2007

(30) Foreign Application Priority Data
Feb. 27, 2004 (JP) 2004-055014
Mar. 3, 2004 (JP) 2004-059749

(51) Int. Cl. B29C 41/24; B29C 41/52; C08J 5/18

(52) U.S. Cl. 428/473.5; 264/622; 428/411.1

(57) ABSTRACT

The present invention relates to a method for continuously producing a synthetic resin film that has stable physical properties across the full width and that is useful for an electronic field. In particular, the present invention relates to a method for continuously producing a synthetic resin film having molecular orientation controlled in the MD direction. That is, the present invention provides a method for continuously producing a synthetic resin film, the method including (A) a step of continuously flow-casting and applying a composition containing a polymer and an organic solvent onto a support to form a gel film; (B) a step of stripping the gel film from the support and fixing both ends of the gel film; and (C) a step of transporting the film with both ends being fixed in a oven, wherein in at least part of step (C), the film is fixed so that substantially no tension is applied in the width direction of the film (TD direction).

### TECHNICAL FIELD

The present invention relates to a method for producing a synthetic resin film, particularly, a method for producing a synthetic resin film having stable physical properties across the full width. For example, the present invention relates to a new method for producing a synthetic resin film having a molecular orientation axis of the synthetic resin film controlled in a machine direction (hereinafter, referred to as “MD direction”). More particularly, the present invention relates to a new method for continuously producing a wide synthetic resin film having a molecular orientation axis controlled in a MD direction across the full width.

### BACKGROUND ART

Demands for higher-density mounting in the electronic technical field and the like have been increased. Thus, demands for higher-density mounting in the technical field using flexible printed circuit boards (hereinafter, referred to as “FPC”) have also been increased. Steps for producing FPCs are broadly divided into a step of laminating a metal layer on a base film; and a step of forming wiring on the surface of the metal. Large changes in dimensions occur in a step of laminating a metal layer while heating the base film; a step of patterning the metal by etching; and a step of heating the formed FPC. FPCs having reduced changes in dimensions in such steps have been needed. To meet the need, the present inventors consider that synthetic resin films, each having molecular orientation controlled in a machine direction (hereinafter, referred to as “MD direction”), are useful. In other words, the inventors consider that the films each having molecular orientation controlled in a MD direction and thus having different physical properties in the machine direction and the direction perpendicular to the machine direction (width direction, hereinafter, referred to as “TD direction”), are useful. More specifically, in laminating the metal layer, it is useful for the reduction of the changes in dimensions (in the patterning step and the step of heating the formed FPC) to use a base film comprising a synthetic resin film having molecular orientation controlled in the MD direction in a step of laminating a metal foil while heating the base film.

The molecular orientation controlled in the machine direction results in high modulus of elasticity in the flow direction (MD direction) of a film and thus reduces the effect of tension. Therefore, it is possible to reduce the changes in dimensions in the steps described above.

Furthermore, for example, the film having molecular orientation controlled in the MD direction has increased modulus of elasticity in the MD direction, thus improving slidability and flexibility of the film oriented in the MD direction.

Thus, a film having molecular orientation controlled in the MD direction will be useful as a film for the FPC and tape automated bonding (TAB), and as a substrate for a chip on film (COF), in the electronic field. Currently, however, a film having molecular orientation controlled in the MD direction and a process for producing a film, the process being capable of desirably controlling molecular orientation of the film, have not been found. In particular, in a process for continuously producing a synthetic resin film, it is significantly difficult to control film properties across the full width. Thus, a process for producing a synthetic resin film having molecular orientation controlled in the MD direction across the full width has not been known.

For example, Patent Document 1 (paragraph 0017) discloses a process for drawing a baked polyimide film in the MD direction while annealing.

Patent Document 2 (paragraph 0021) discloses a process for drawing a film at a draw ratio of 1.0 to 1.5 in the MD direction and 0.5 to 0.99 in the TD direction in forming the film.

Patent Document 3 (paragraph 0010) discloses a process for producing a uniaxially drawn polyimide film by drawing a gel film swollen to 3 to 100 times its normal size with a solvent.

Patent Document 4 (page 2, upper right column, line 15) discloses a process for producing a polyimide film oriented in the MD direction by zone drawing at 250° C. or more under a tension of 10 kg/mm² or more.

Patent Document 5 (paragraph 0007) discloses a production process including swelling a film, composed of an aromatic polyimide precursor, containing a residual solvent with a swelling agent, drawing the resulting film in at least one axial direction, removing the swelling agent from the film, and drying the resulting film by heating.

Patent Document 6 (paragraph 0014) discloses a process for producing a uniaxially drawn polyimide film by drawing a gel film swollen to 3 to 20 times its normal size with a solvent.

Patent Document 7 (paragraph 0020) discloses a process in which a self-supporting polyimide film necessarily containing a 3,3′4,4′-biphenyltetracarboxylic acid component and a p-phenylenediamine component is introduced into an oven while both ends of the film are held, and then the distance between the held ends is gradually reduced up to a temperature of 300° C. at which shrinkage of the self-supporting film is substantially completed.

Patent Document 8 (paragraph 0008) discloses a process for producing a polyimide film by fixing both ends of a gel film, setting a distance between the fixed ends so that the film width is gradually reduced in an oven, setting the distance between the fixed ends so that the film width is gradually increased, and further setting the distance between the fixed ends so that the film width is gradually reduced again.

However, any patent document described above does not disclose a step of transporting a gel film in an oven while both ends of the film are fixed so that substantially no tension is applied in the TD direction of the gel film, which is a characteristic of the present invention, and is completely different from the present invention.

[Patent Document 1] Japanese Unexamined Patent Publication Tokukaihei 8-174659

[Patent Document 2] Japanese Unexamined Patent Publication Tokukaihei 11-156936

[Patent Document 3] Japanese Unexamined Patent Publication Tokukaihei 2003-128811

[Patent Document 4] Japanese Unexamined Patent Publication Tokukaisho 63-197628

[Patent Document 5] Japanese Unexamined Patent Publication Tokukai 2002-1804

[Patent Document 6] Japanese Unexamined Patent Publication Tokukai 2003-145561

[Patent Document 7] Japanese Unexamined Patent Publication Tokukai 2002-179821

[Patent Document 8] Japanese Unexamined Patent Publication Tokukai 2004-331792

### DISCLOSURE OF INVENTION

As described above, a process for producing a synthetic resin having molecular orientation controlled in the MD direction across the full width, the film being particularly useful in the electronic technical field, for example, FPCs, has not been obtained. The present inventors have conducted intensive studies aimed at continuously producing a synthetic resin film having molecular orientation controlled in the MD direction across the full width, particularly a polyimide film, the film being particularly useful in the electronic field. As a result, the present invention has been completed.

The above-described problems can be solved by the following new method for producing a synthetic resin film according to the present invention.

1) A method for continuously producing a synthetic resin film includes at least the following steps (A) to (C):

(A) a step of continuously flow-casting and applying a composition containing a polymer and an organic solvent onto a support to form a gel film;

(B) a step of stripping the gel film from the support and fixing both ends of the gel film; and

(C) a step of transporting the film with both ends being fixed in an oven, wherein step (C) includes at least a substep (C-1) of transporting the film with both ends being fixed so that substantially no tension is applied in the width direction (transverse direction (TD direction)) of the film.

2) The method for producing the synthetic resin film according to item 1), wherein, in step (C), both ends are fixed so that substantially no tension is applied in the TD direction at an entrance of the oven.

3) The method for producing the synthetic resin film according to item 2), wherein the oven includes at least two oven units and a temperature of the first oven unit is set at 300° C. or less.

4) The method for producing the synthetic resin film according to any one of items 1) to 3), wherein, in step (C), both ends are fixed so that the distance X between the fixed ends and the film width Y between the fixed ends satisfy the following formula:
20.0≧(Y−X)/Y×100>0.00

5) The method for producing the synthetic resin film according to any one of items 1) to 4), wherein step (C) includes at least a substep (C-2) of stretching the film in the TD direction.

6) The method for producing the synthetic resin film according to item 5), wherein, in substep (C-2), the film is stretched in the TD direction so that the distance Z between the fixed ends in the TD direction before the film is stretched and the distance W between the fixed ends after the film has been stretched satisfy the following formula:
40.0≧(W−Z)/Z×100>0.00

7) The method for producing the synthetic resin film according to any one of items 1) to 6), wherein the synthetic resin film is a polyimide film.

8) A synthetic resin film produced by the method for producing the synthetic resin film according to any one of items 1) to 7).

According to a method for producing a synthetic resin film, it is possible to obtain a synthetic resin film having molecular orientation controlled in the MD direction. In particular, it is possible to obtain a synthetic resin film having molecular orientation controlled in the MD direction across the full width even when the film is a wide synthetic resin film continuously produced.

### BRIEF DESCRIPTION OF DRAWINGS

FIG. 1 is a schematic view showing an apparatus for producing a polyimide film.

FIG. 2 is a schematic view illustrating a state of the polyimide film fixed between fixing units for fixing the polyimide film.

FIG. 3 is a schematic view showing a sampling manner for measuring a degree of orientation and an orientation angle in examples and comparative examples.

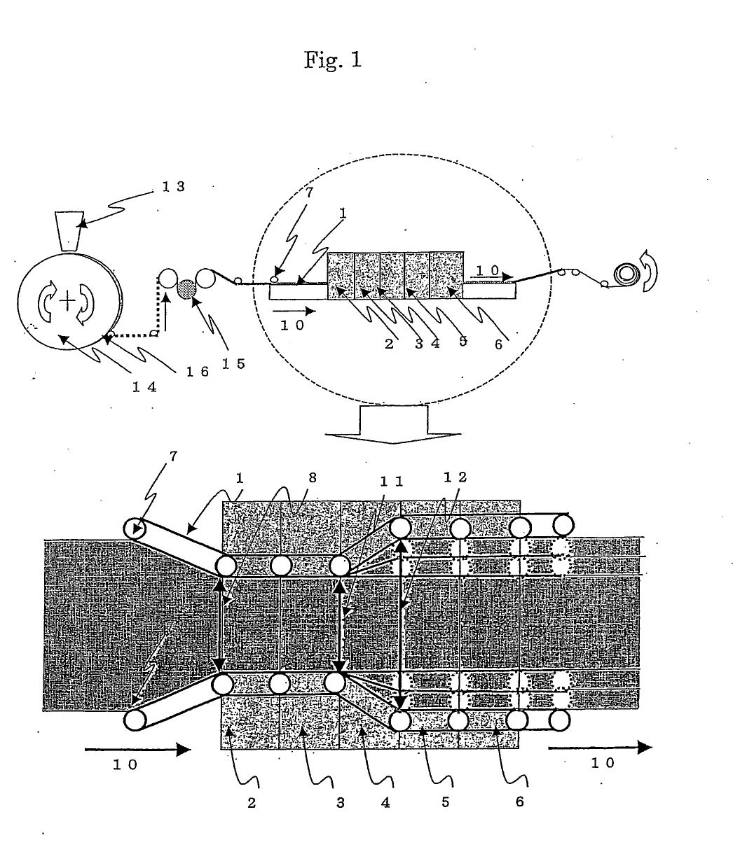

In FIGS. 1 and/or 2, reference numeral 1 represents a film-transporting device, reference numerals 2, 3, 4, 5, and 6 each represent an oven unit, reference numeral 7 represents the starting point to fix a film, reference numeral 8 represents the distance X between film-fixing units, reference numeral 9 represents the film width Y in the TD direction of a gel film fixed between the film-fixing units, reference numeral 10 represents the film transfer direction, reference numeral 11 represents the distance Z between the fixed ends in the TD direction before stretching of the film, reference numeral 12 represents the distance W between the fixed ends in the TD direction when the film has been stretched, reference numeral 13 represents a unit (die) for flow-casting and applying an organic solvent solution, reference numeral 14 represents a support for the organic solvent solution, reference numeral 15 represents a unit for applying tension to the gel film, and reference numeral 16 represents a position at which the gel film is stripped off.

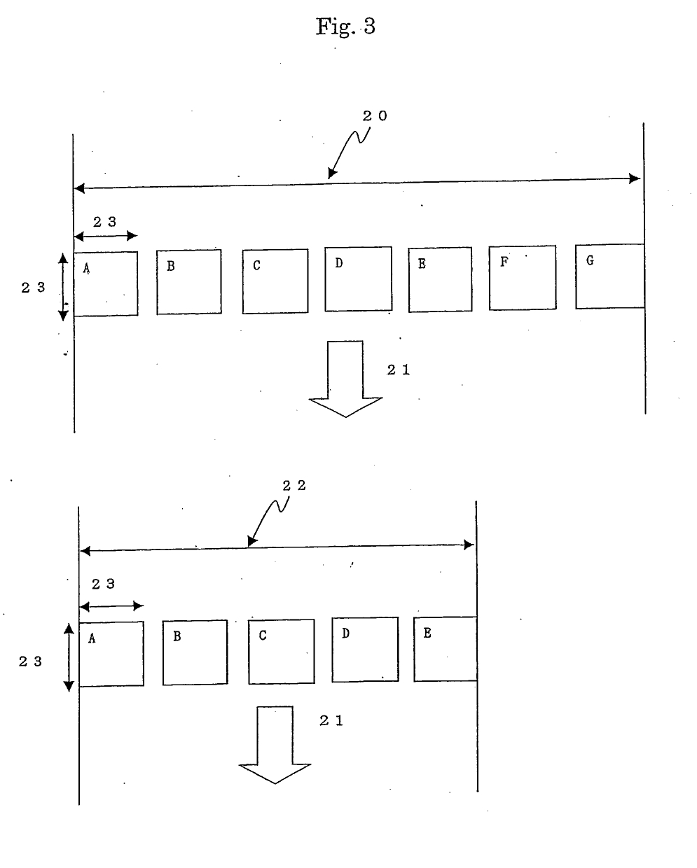

In FIG. 3, reference numeral 20 represents a film having a width of 800 mm or more, reference numeral 21 represents the MD direction (film transfer direction), reference numeral 22 represents a film having a width of less than 800 mm, and reference numeral 23 represents a film sample having a width of 40 mm.

### BEST MODE FOR CARRYING OUT THE INVENTION

The present invention provides a method for continuously producing a synthetic resin film including at least the following steps (A) to (C):

(A) a step of continuously flow-casting and applying a composition containing a polymer and an organic solvent onto a support to form a gel film;

(B) a step of stripping the gel film from the support and fixing both ends of the gel film; and

(C) a step of transporting the film with both ends being fixed in an oven, wherein step (C) includes at least a substep (C-1) of transporting the film with both ends being fixed so that substantially no tension is applied in the width direction (transverse direction (TD direction)) of the film. The steps will be described in detail below.

Step (A)

Step (A) is a step of continuously flow-casting and applying a composition containing a polymer and an organic solvent onto a support to form a gel film. A material generally expressed as a “polymer” is suitably applicable for the method for producing the synthetic resin film according to the present invention. Examples of the synthetic resin film composed of the polymer include a polyimide (PI) film, a polyamide (PA) film, a poly(ethylene naphthalate) (PEN) film, a polyamide-imide film, a polypropylene film, a polycarbonate (PC) film, a polyphenylenesulfide (PPS) film, a liquid crystal polymer (LCP) film, a polyethylene terephthalate (PET) film, a polyethylene (PE) film, a polyvinyl alcohol (PVA) film, a polytetrafluoroethylene (PTFE) film, a polyvinylidene fluoride (PVDF) film, and a polyvinyl fluoride (PVF) film. In particular, a polyimide film is suitably used as a synthetic resin film for electronic and electric applications.

The composition containing the polymer and the organic solvent according to the present invention may contain the polymer dissolved in the organic solvent and may contain a precursor of a polymer, constituting the synthetic resin film as a final product, dissolved in an organic solvent. Alternatively, the composition may further contain any other component, for example, a reagent that can react with the polymer as the precursor.

For example, in producing a polyimide film as the synthetic resin film, a composition containing a polyamic acid, which is a precursor of polyimide, dissolved in an organic solvent may be used. This composition may contain, for example, a stripping agent, an imidization catalyst, and a dehydrating agent. Alternatively, a composition containing a polyimide resin dissolved in an organic solvent may also be used. In producing other resin films, for example, a PET film, a composition containing a polyethylene terephthalate dissolved in an organic solvent may be used.

The solid content of the polymer in an organic solvent solution suitably used as the composition described above is preferably 5 to 40 percent by weight relative to the total solution weight because it is possible to reduce the amount of the organic solvent removed in the production step. In the method for producing the synthetic resin film with a solid content exceeding the range described above, a solution having any solid content may be used as long as the solution has flowability, can be discharged through a slit of a die, and can be cast through the die onto a support to produce a self-supporting film.

A solvent suitably used as the organic solvent varies depending on a polymer that is dissolved in the solvent. For example, in producing a polyimide film, examples of the solvent include ureas such as tetramethylurea and N,N-dimethylethylurea; sulfoxides or sulfones such as dimethyl sulfoxide, diphenyl sulfone, and tetramethyl sulfone; amides such as N,N-dimethylacetamide (DMAc), N,N-dimethylformamide (DMF), N-methyl-2-pyrrolidone (NMP), γ-butyrolactone, and hexamethylphosphoric triamide; aprotic solvents such as phosphoryl amides; alkyl halides such as chloroform and methylene chloride; aromatic hydrocarbons such as benzene and toluene; phenols such as phenol and cresol; and ethers such as dimethyl ether, diethyl ether, and p-cresol methyl ether. Usually, these solvents is used alone, but may be appropriately used in combination, as required. Among these, amides such as DMF, DMAc, and NMP are preferably used as the solvent from the standpoint of high solubility of a polymer in amides.

For example, when a polyimide film is produced as the synthetic resin film, a polyamic acid, which is a precursor of polyimide, may be used as the polymer in step (A). The polyamic acid is not particularly limited but is preferably used as a polyamic acid solution prepared by reacting substantially equimolar amounts of an acid dianhydride and a diamine in an organic solvent. Any polymerization process for the synthesis of the polyamic acid may be used. For example, the following polymerization processes may be employed: a random copolymerization process of dissolving or dispersing at least one diamine in an organic solvent, adding at least one acid dianhydride to the resulting solution or dispersion, and then performing polymerization; a random copolymerization process of adding at least one diamine to a solution or dispersion containing at least one acid dianhydride and then performing polymerization; and a polymerization process for further adding diamine or acid dianhydride to a solution prepared by polymerizing at least one diamine with at least one acid dianhydride in order to complete the polymerization. However, the subject of the present invention relates to a method for producing a synthetic resin film. A polymerization process for producing such a solution of a polyamic acid, which is a precursor of polyimide, is not particularly limited. Any polymerization process may be used.

Examples of the organic solvent used in polymerization for the polyamic acid include ureas such as tetramethylurea and N,N-dimethylethylurea; sulfoxides or sulfones such as dimethyl sulfoxide, diphenyl sulfone, and tetramethyl sulfone; amides such as N,N-dimethylacetamide (DMAc), N,N-dimethylformamide (DMF), N-methyl-2-pyrrolidone (NMP), γ-butyrolactone, and hexamethylphosphoric triamide; aprotic solvents such as phosphoryl amides; alkyl halides such as chloroform and methylene chloride; aromatic hydrocarbons such as benzene and toluene; phenols such as phenol and cresol; and ethers such as dimethyl ether, diethyl ether, and p-cresol methyl ether. Usually, these solvents is used alone, but may be appropriately used in combination, as required. Among these, amides such as DMF, DMAc, and NMP are preferably used as the solvent from the standpoint of high solubility of a polymer in amides.

With respect to the polyamic acid solid content in the polyamic acid solution, the polyamic acid is dissolved in an organic solvent, in an amount of 5 to 40 percent by weight, preferably 10 to 30 percent by weight, and more preferably 13 to 25 percent by weight, in view of handleability. The average molecular weight of the polyamic acid is preferably 10,000 or more measured by GPC using polyethylene glycol (PEG) standard, in view of physical properties of the film.

For the measurement of viscosity, the polyamic acid solution is maintained at 23° C. for 1 hour in a water bath, and then the viscosity of the polyamic acid solution is measured with a Brookfield type viscometer using a No. 7 rotor at 4 rpm. The viscosity is preferably 50 Pa·s to 1,000 Pa·s, more preferably 100 Pa·s to 500 Pa·s, and most preferably 200 Pa·s to 350 Pa·s, in view of handleability in forming a film product.

Examples of the acid dianhydride suitably used in producing the polyamic acid solution according to the present invention include ester-acid anhydrides such as p-phenylenebis(trimellitic acid monoester anhydride), p-methylphenylenebis(trimellitic acid monoester anhydride), p-(2,3-dimethylphenylene)bis(trimellitic acid monoester anhydride), 4,4′-biphenylenebis(trimellitic acid monoester anhydride), 1,4-naphthalenebis(trimellitic acid monoester anhydride), 2,6-naphthalenebis(trimellitic acid monoester anhydride), and 2,2-bis(4-hydroxyphenyl)propanedibenzoate-3,3′,4,4′-tetracarboxylic dianhydride; and ethylenetetracarboxylic dianhydride, 1,2,3,4-butanetetracarboxylic dianhydride, cyclopentanetetracarboxylic dianhydride, pyromellitic dianhydride, 1,2,3,4-benzenetetracarboxylic dianhydride, 3,3′,4,4′-biphenyltetracarboxylic dianhydride, 2,2′,3,3′-biphenyltetracarboxylic dianhydride, 3,3′,4,4′-benzophenonetetracarboxylic dianhydride, 2,2′,3,3′-benzophenonetetracarboxylic dianhydride, bis(2,3-dicarboxyphenyl)methane dianhydride, bis(3,4-dicarboxyphenyl)methane dianhydride, 1,1-bis(2,3-dicarboxyphenyl)ethane dianhydride, 2,2-bis(3,4-dicarboxyphenyl)propane dianhydride, 2,2-bis(2,3-dicarboxyphenyl)propane dianhydride, bis(3,4-dicarboxyphenyl)ether dianhydride, bis(2,3-dicarboxyphenyl)ether dianhydride, bis(2,3-dicarboxyphenyl) sulfone dianhydride, 2,3,6,7-naphthalenetetracarboxylic dianhydride, 1,4,5,8-naphthalenetetracarboxylic dianhydride, 1,2,5,6-naphthalenetetracarboxylic dianhydride, 2,3,6,7-anthracenetetracarboxylic dianhydride, 1,2,7,8-phenanthrenetetracarboxylic dianhydride, 3,4,9,10-perylenetetracarboxylic dianhydride, 4,4-(p-phenylenedioxy)diphthalic dianhydride, 4,4-(m-phenylenedioxy)diphthalic dianhydride, and 2,2-bis[(2,3-dicarboxyphenoxy)phenyl]propane dianhydride. These may be used alone or in combination.

Among these acid dianhydride, at least one selected from pyromellitic acid, 1,2,3,4-benzenetetracarboxylic dianhydride, 3,3′,4,4′-biphenyltetracarboxylic dianhydride, 2,2′,3,3′-biphenyltetracarboxylic dianhydride, 3,3′,4,4′-benzophenonetetracarboxylic dianhydride, 2,2′,3,3′-benzophenonetetracarboxylic dianhydride, and p-phenylenebis (trimellitic acid monoester anhydride) is preferably used in order to impart heat resistance to the polyimide film and improve modulus of elasticity of the film to facilitate orientation of the polyimide film.

Improvement of modulus of elasticity of the polyimide film results in the occurrence of in-plane contraction stress of the film due to volumetric shrinkage in evaporating a residual volatile component in the film, thus accelerating in-plane molecular orientation. As a result, molecular orientation of the polyimide film proceeds.

Examples of the amine compound include p-phenylenediamine, m-phenylenediamine, o-phenylenediamine, 3,3′-diaminodiphenyl ether, 3,4′-diaminodiphenyl ether, 4,4′-diaminodiphenyl ether, 3,3′-diaminodiphenylsulfide, 3,4′-diaminodiphenylsulfide, 4,4′-diaminodiphenylsulfide, 3,3′-diaminodiphenyl sulfone, 3,4′-diaminodiphenyl sulfone, 4,4′-diaminodiphenyl sulfone, 3,3′-diaminobenzophenone, 3,4′-diaminobenzophenone, 4,4′-diaminobenzophenone, 3,3′-diaminodiphenylmethane, 3,4′-diaminodiphenylmethane, 4,4′-diaminodiphenylmethane, 2,2-bis(4-aminophenyl)propane, 2,2-bis(3-aminophenyl)propane, 2-(3-aminophenyl)-2-(4-aminophenyl)propane, 2,2-bis(4-aminophenyl)-1,1,1,3,3,3-hexafluoropropane, 2,2-bis(3-aminophenyl)-1,1,1,3,3,3-hexafluoropropane, 2-(3-aminophenyl)-2-(4-aminophenyl)-1,1,1,3,3,3-hexafluoropropane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(3-aminobenzoyl)benzene, 1,4-bis(3-aminobenzoyl)benzene, 1,3-bis(4-aminobenzoyl)benzene, 1,4-bis(4-aminobenzoyl)benzene, 3,3′-diamino-4-phenoxybenzophenone, 4,4′-diamino-5-phenoxybenzophenone, 3,4′-diamino-4-phenoxybenzophenone, 3,4′-diamino-5-phenoxybenzophenone, 4,4′-bis(4-aminophenoxy)biphenyl, 3,3′-bis(4-aminophenoxy)biphenyl, 3,4′-bis(3-aminophenoxy)biphenyl, bis[4-(4-aminophenoxy)phenyl]ketone, bis[4-(3-aminophenoxy)phenyl]ketone, bis[3-(4-aminophenoxy)phenyl]ketone, bis[3-(3-aminophenoxy)phenyl]ketone, 3,3′-diamino-4,4′-diphenoxydibenzophenone, 4,4′-diamino-5,5′-diphenoxybenzophenone, 3,4′-diamino-4,5′-diphenoxybenzophenone, bis[4-(4-aminophenoxy)phenyl]sulfide, bis[3-(4-aminophenoxy)phenyl]sulfide, bis[4-(3-aminophenoxy)phenyl]sulfide, bis[3-(4-aminophenoxy)phenyl]sulfide, bis[3-(3-aminophenoxy)phenyl]sulfide, bis[3-(4-aminophenoxy)phenyl]sulfone, bis[4-(4-aminophenyl) sulfone, bis[3-(3-aminophenoxy)phenyl]sulfone, bis[4-(3-aminophenyl) sulfone, bis[4-(3-aminophenoxy)phenyl]ether, bis[4-(4-aminophenoxy)phenyl]ether, bis[3-(3-aminophenoxy)phenyl]ether, bis[4-(3-aminophenoxy)phenyl]methane, bis[4-(4-aminophenoxy)phenyl]methane, bis[3-(3-aminophenoxy)phenyl]methane, bis[3-(4-aminophenoxy)phenyl]methane, 2,2-bis[4-(3-aminophenoxy)phenyl]propane, 2,2-bis[4-(4-aminophenoxy)phenyl]propane, 2,2-bis[3-(3-aminophenoxy)phenyl]propane, 2,2-bis[4-(3-aminophenoxy)phenyl]-1,1,1,3,3,3-hexafluoropropane, 2,2-bis[4-(4-aminophenoxy)phenyl]-1,1,1,3,3,3-hexafluoropropane, 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 1,4-bis[4-(3-aminophenoxy)benzoyl]benzene, 1,3-bis[4-(3-aminophenoxy)benzoyl]benzene, 1,3-bis(3-amino-4-phenoxybenzoyl)benzene, 1,4-bis(3-amino-4-phenoxybenzoyl)benzene, 1,3-bis(4-amino-5-phenoxybenzoyl)benzene, 1,3-bis(4-amino-5-biphenoxybenzoyl)benzene, 1,4-bis(4-amino-5-biphenoxybenzoyl)benzene, 1,3-bis(3-amino-4-biphenoxybenzoyl)benzene, 1,4-bis(3-amino-4-biphenoxybenzoyl)benzene, 1,4-bis[4-(4-aminophenoxy)-α,α-dimethylbenzyl]benzene, 1,3-bis[4-(4-aminophenoxy)-α,α-dimethylbenzyl]benzene, 1,3-bis[4-(4-amino-6-trifluoromethylphenoxy)-α, α-dimethylbenzyl]benzene, 1,3-bis[4-(4-amino-6-fluoromethylphenoxy)-α, α-dimethylbenzyl]benzene, 1,3-bis[4-(4-amino-6-methylphenoxy)-α,α-dimethylbenzyl]benzene, 1,3-bis[4-(4-amino-6-cyanophenoxy)-α,α-dimethylbenzyl]benzene, and diaminopolysiloxane. These may be used alone or in combination.

Among these, at least one selected from p-phenylenediamine, m-phenylenediamine, 3,3′-diaminodiphenyl ether, 3,4′-diaminodiphenyl ether, 4,4′-diaminodiphenyl ether, and 2,2-bis[4-(4-aminophenoxy)phenyl]propane may be preferably used in order to improve heat resistance of the polyimide film and impart rigidity of the film. Furthermore, p-phenylenediamine and/or 3,4′-diaminodiphenyl ether is preferably used as an essential component in order to improve modulus of elasticity of the polyimide film to facilitate orientation of the polyimide film.

Particularly preferable polyimide films include (1) a film composed of a polyimide prepared from four monomers, i.e., p-phenylenediamine, 4,4′-diaminodiphenyl ether, pyromellitic acid dianhydride, and p-phenylenebis(trimellitic acid monoester anhydride); (2) a film composed of a polyimide prepared from p-phenylenediamine, 4,4′-diaminodiphenyl ether, pyromellitic acid dianhydride, and 3,3′,4,4′-biphenyltetracarboxylic dianhydride; (3) a film composed of a polyimide prepared from p-phenylenediamine, 4,4′-diaminodiphenyl ether, pyromellitic acid dianhydride, and 3,3′,4,4′-benzophenonetetracarboxylic dianhydride; (4) a film composed of a polyimide prepared from p-phenylenediamine, 4,4′-diaminodiphenyl ether, pyromellitic acid dianhydride, p-phenylenebis(trimellitic acid monoester anhydride), and 3,3′,4,4′-biphenyltetracarboxylic dianhydride; (5) a film composed of a polyimide prepared from p-phenylenediamine, 4,4′-diaminodiphenyl ether, and 3,3′,4,4′-biphenyltetracarboxylic dianhydride; (6) a film composed of a polyimide prepared from 4,4′-diaminodiphenyl ether, 3,4′-diaminodiphenyl ether, and pyromellitic acid dianhydride; (7) a film composed of a polyimide prepared from p-phenylenediamine, 4,4′-diaminodiphenyl ether, 2,2-bis[4-(4-aminophenoxy)phenyl]propane, pyromellitic acid dianhydride, and 3,3′,4,4′-biphenyltetracarboxylic dianhydride; and (8) a film composed of a polyimide prepared from p-phenylenediamine, and 3,3′,4,4′-biphenyltetracarboxylic dianhydride. These films have an advantage that molecular orientation is easily controlled and thus are preferably used.

In this step, examples of a process for continuously flow-casting the composition containing the polymer and the organic solvent onto the support, which will be described below, include, in the case of a polyimide film, (1) a process for directly flow-casting a solution containing the polyamic acid; (2) a process for adding an imidization catalyst to the solution containing the polyamic acid, and then flow-casting the resulting solution; (3) a process for adding an imidization catalyst and a dehydrating agent to the solution containing the polyamic acid, and then flow-casting the resulting solution; and (4) a process for adding a stripping agent to the resulting solution, and then flow-casting the resultant solution. The imidization catalyst, dehydrating agent, and stripping agent will now be described.

Examples of the imidization catalyst in this step include aliphatic tertiary amines such as trimethylamine, triethylamine, and tributylamine; aromatic tertiary amines such as dimethylaniline; and heterocyclic tertiary amines such as pyridine, isoquinoline, and picoline. Examples of the dehydrating agent include aliphatic acid anhydrides such as acetic anhydride; and aromatic acid anhydrides. For example, acetic acid may be used as the stripping agent.

To reduce contaminants and defects in the film, a step of removing insoluble materials and contaminants with, for example, a filter is preferably provided before the imidization catalyst, the dehydrating agent, and the stripping agent are added to the organic solvent solution containing the polyamic acid. The pore size of the filter is ½, preferably ⅕, and more preferably 1/10, of the thickness of the film as a final product.

With respect to the imidization catalyst content in the polyamic acid solution when the imidization catalyst is added alone, depending on the structural formula of the polyamic acid, (the imidization catalyst)/(the number of moles of the amido group in the polyamic acid)=10 to 0.01 is preferable. More preferably, (the imidization catalyst)/(the number of moles of the amido group in the polyamic acid)=5 to 0.5.

With respect to the dehydrating agent content and the imidization catalyst content in the polyamic acid solution when both the dehydrating agent and the imidization catalyst are added, depending on the structural formula of the polyamic acid, (the number of moles of the dehydrating agent)/(the number of moles of the amido group in the polyamic acid)=10 to 0.01 and (the imidization catalyst)/(the number of moles of the amido group in the polyamic acid)=10 to 0.01 are preferable. (The number of moles of the dehydrating agent)/(the number of moles of the amido group in the polyamic acid)=5 to 0.5 and (the imidization catalyst)/(the number of moles of the amido group in the polyamic acid)=5 to 0.5 are more preferable. In this case, the solution may further contain a reaction retardant such as acetylacetone. The contents of the dehydrating agent and the catalyst in the polyamic acid solution may be determined by the period of time from mixing of the polyamic acid with a mixture of the dehydrating agent and the catalyst to starting of an increase in viscosity at 0° C. (pot life). In typical, the pot life is 0.1 to 120 minutes and more preferably 0.5 to 60 minutes.

A heat stabilizer, an antioxidant, an ultraviolet absorber, an antistatic agent, a flame retardant, a pigment, a dye, a fatty acid ester, and an organic lubricant such as a wax, may be added to the extent to which the present invention is not impaired. To impart slidability, abrasion resistance, scratch resistance, and the like, the composition may further contain clay, mica, titanium oxide, calcium carbonate, kaolin, talc, wet-process silica, dry-process silica, colloidal silica, calcium phosphate, calcium hydrogen phosphate, barium sulfate, a surfactant, inorganic particles composed of alumina or zirconia, organic particles composed of acrylic acids or styrene, and internal particles that are deposited by adding a catalyst during polymerization reaction.

In the present invention, higher modulus of elasticity of the polyimide film used facilitates orientation control. The modulus of elasticity significantly depends on not only the composition, but also the production process and the like of the polyimide film. The modulus of elasticity of the polyimide film as a final product is measured in the MD direction and in the TD direction (the direction perpendicular to the MD direction). The average value of the resulting measurements is defined as the modulus of elasticity of the film. The modulus of elasticity of the film is preferably 4.0 to 7.0 GPa in order to control the orientation of the polyimide film. Higher modulus of elasticity facilitates orientation of the polyimide film. In the present invention, a polyimide film in which the modulus of elasticity is in the range above is preferable. Such a polyimide film is produced by appropriately selecting the acid dianhydride or diamine used in preparing the polyimide or appropriately changing the polymerization process after appropriately selecting the monomers to be used, and appropriately selecting the production process (a drying process on a belt portion, the temperature in a tentering oven, and the like) in order to increase the modulus of elasticity.

The thus-prepared composition is continuously flow-cast and applied. Any support can be used as long as the support is not dissolved in the resin solution and is capable of resisting heat applied for removing the organic solvent from the synthetic resin solution. A metal drum or an endless belt produced by connecting metal plates to each other is particularly preferably used for drying the applied solution. A metal is preferably used as the material of the endless belt or the drum. In particular, SUS (stainless steel) is more preferably used. The surface is preferably plated with a metal such as chromium, titanium, nickel, or cobalt, because of improvement of an affinity for the solvent or ease of stripping a dried synthetic resin film. The endless belt or the metal drum preferably has a smooth surface. Alternatively, the endless belt or the metal drum may have a myriad of projections and depressions. Each of the projections and depressions produced on the endless belt or the metal drum preferably has a diameter of 0.1 to 100 μm and a depth of 0.1 to 100 μm. By producing the projections and depressions on the metal surface, it is possible to form minute protrusions on the surface of the synthetic resin film, thus reducing the occurrence of a scratch due to friction between the films or improving slidability between the films.

The gel film in the present invention refers to a polymeric resin film that is prepared by heating and drying the organic solvent solution containing the polymer and the organic solvent and that contains part of the solvent or a reaction product remaining in the polymeric film (hereinafter referred to as “residual components”). In the step of producing the polyimide film, the organic solvent in which the polyamic acid is dissolved, the imidization catalyst, the dehydrating agent, and the reaction product (water-absorbing component of the dehydrating agent, water) remain as residual components in the gel film. The residual component ratio c in the gel film is calculated by the following expression:
c=b/a×100 (expression 1)
wherein a represents the weight (g) of the completely dried synthetic resin; and b represents the weight (g) of the residual component in the gel film. The residual component ratio is preferably 500% or less, more preferably 25% to 200%, and most preferably 30% to 150%.

A residual component ratio of 500% or more results in deterioration of handleability. Furthermore, an increase in the amount of the solvent removed causes high shrinkage of the film, thus resulting in difficulty to control the orientation. Therefore, the residual component ratio of more than 500% is not preferable. A residual component ratio of 25% or more facilitates orientation of the polyimide film in the MD direction and stabilization of the physical properties of the film in the width direction, and is thus preferable.

The weight a of the completely dried synthetic resin and the weight b of the residual component are determined as follows. After the weight d of a 100 mm×100 mm gel film is measured, the gel film is dried in an oven at 300° C. for 20 minutes and cooled to room temperature. The weight measured at this stage is defined as the weight a of the completely dried synthetic resin. The residual component weight b is calculated based on the gel film weight d and the completely dried synthetic resin weight a according to the expression b=d−a.

In the step of producing the gel film, the temperature, air velocity, and exhaust velocity are preferably determined so that the residual component ratio is in the range described above. In particular, in the step of producing the polyimide film, the organic solvent solution containing the polymer and the organic solvent is preferably heated and dried in a range of 50° C. to 200° C. and particularly preferably 50° C. to 180° C. The drying time is preferably in a range of 1 to 300 minutes. The drying is preferably performed according to multi-stage temperature control.

Step (B)

Step (B) is a step of stripping the gel film from the support and continuously fixing both ends of the gel film. The step of fixing the ends of the gel film according to the present invention is a step of fixing the ends of the gel film with fixing units such as pin seats or clips, the fixing units being generally used in a film production apparatus. An example of a position for fixing both ends is a starting point 7 (FIG. 1) to fix the ends of the film with end-fixing units (pin seats or clips) mounted on a film-transporting device 1 (FIG. 1).

To fix the film so that substantially no tension is applied in the TD direction in at least part of step (C) described below, the film may be fixed so that substantially no tension is applied in the TD direction when the ends of the gel film are fixed in step (B). That is, the film is fixed so that substantially no tension is applied in the TD direction, and then transferred to step (C). Specifically, the ends are fixed so that the film is loosened.

Step (C)

Step (C) is a step of transporting the film with both ends being fixed in an oven. In this step, it is important that the film be transported so that substantially no tension is applied in the width direction of the film (TD direction) in at least part of step (C), in order to obtain a synthetic resin film having orientation controlled in the MD direction.

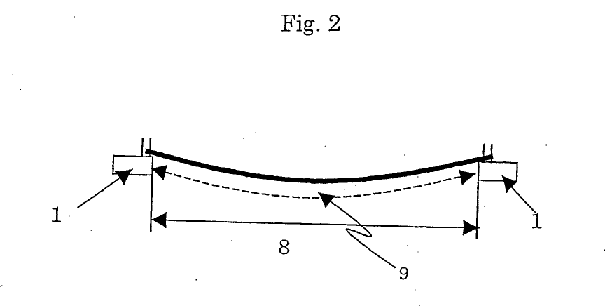

Here, substantially no tension in the TD direction means that except for the tension due to its own weight, tensile force due to mechanical handling is not applied to the film in the TD direction. That is, the film width 9 (FIG. 2) between the fixed ends is longer than the distance 8 (FIG. 2) between the fixed ends of the film. The film under such circumstances is defined as a film to which substantially no tension is applied. As shown in FIG. 2, a film is fixed with the fixing units. The length represented by reference numeral 8 is defined as the distance between the fixed ends of the film. Usually, the film is tight with tension. In this case, the distance 8 between the fixed ends of the film is equal to the film width 9 between the fixed ends. In the present invention, as shown in FIG. 2, the distance 8 between the fixed ends of the film is different from the film width 9, the distance between the fixed ends of the film being smaller. Specifically, the film is fixed in a loosened state. In particular, from the standpoint that the molecular orientation in the MD direction is easily controlled, the film is preferably fixed so that when the distance 8 between the fixed ends of the film is defined as X and the film width 9 between the fixed ends is defined as Y, X and Y satisfy the expression below.
20.0≧(Y−X)/Y×100>0.00 (expression 2)

If the value (Y−X)/Y×100 (for the sake of convenience, also referred to as the “TD shrinkage ratio”) is exceeding the above range, it may become difficult to stably control the looseness of the film, resulting in a variation in the amount of looseness with respect to the traveling direction. Furthermore, depending on the cases, the film may become unfastened from the end-fixing units, and stable production of the film may become difficult. The value (Y−X)/Y×100 is more preferably 15.0≧(Y−X)/Y×100>0.00, and particularly preferably, 10.0≧(Y−X)/Y×100>0.00.

In step (C) of the present invention, to produce a film having an orientation axis in the MD direction across the full width, the film being fixed at the entrance of an oven so that substantially no tension is applied in the TD direction is preferable. There are two processes for transporting the film with both ends being fixed at the entrance of the oven so that substantially no tension is applied in the TD direction: a first process in which when both ends of the gel film are fixed in step (B), both ends of the gel film are fixed so that substantially no tension is applied in the TD direction, and then transferred to step (C); and a second process in which after step (B), an operation for reducing the distance between the fixed ends is performed (process shown in FIG. 1), and then transferred to step (C). In the first process, it is preferable to fix both ends of the gel film so that expression (2) is satisfied. In the second process, it is preferable to reduce the distance between the fixed ends so that expression (2) is satisfied.

After the first or second process, a process for further reducing the distance between the fixed ends may be performed in the oven in step (C) (third process). The third process for reducing the distance between the fixed ends is preferably performed at 300° C. or less, more preferably 250° C. or less, and most preferably 200° C. or less. When the third process is performed at higher temperatures exceeding 300° C., there is a tendency to be difficult to control orientation of the film. In particular, there is a tendency to be difficult to control orientation at the ends of the film.

As described above, in the present invention, it is important to pass the state in which substantially no tension is applied to the gel film in the TI) direction directly before the gel film is heated.

In step (C), the film is dried, and imidization proceeds. As a result, the film shrinks to a certain extent. When the film is fixed at the entrance of the oven so that substantially no tension is applied in the TD direction and is transported, the film width becomes small because of shrinkage of the film due to heating. As a result, the distance between the fixed ends becomes equal to the film width between the fixed ends, thus producing a film with no wrinkle.

In the present invention, step (C) may include a substep (C-2) of stretching the film in the TD direction. By further including the substep (C-2), it is possible to control the degree of orientation of the film. The degree of orientation is an index of the degree of molecular orientation of a film. MOR and MOR-c indicating the degree of orientation will be described below. When a specimen in the form of a film or sheet is irradiated with microwave, microwave absorption intensity depends on anisotropy of the specimen. That is, by measuring microwave transmission intensity in all directions (360°), polar coordinates of the transmission intensity are determined (orientation pattern). MOR is a value calculated from the ratio of the major axis to the minor axis of the polar coordinates of the transmission intensity. In the present invention, MOR is defined as the degree of orientation indicating a molecular orientation state. An orientation angle and the degree of anisotropy can be obtained from the orientation pattern.

MOR can be measured using a microwave molecular orientation analyzer Model MOA2012A manufactured by Oji Scientific Instruments.

MOR-c is defined as a value determined by converting MOR with reference to the thickness. The degree of orientation is proportional to the thickness. Thus, MOR measured with the analyzer is converted by using expression (3) into corrected MOR of a film having a thickness of 75 μm, the corrected MOR being defined as MOR-c.
MOR-c=(tc/t×(MOR−1))+1 (expression 3)
where t=thickness of specimen
tc=desired reference thickness (75 μm)
MOR=value obtained by the above measurement
MOR-c=corrected MOR

Substituting 75 into tc in the expression yields a corrected MOR value. The resulting MOR-c value represents that when MOR-c is closer to 1.000, the film has a lower degree of orientation and is isotropic.

When a film has a higher degree of isotropy and a lower degree of orientation, the difference of the physical properties of the film in the MD direction and the TD direction can be eliminated. There is an advantage in that a synthetic resin film, which can be used regardless of the direction of use, can be produced.

Specifically, when a synthetic resin film having orientation in the MD direction and indicating a lower degree of orientation is desired, a production process including the substep (C-2) should be employed.

In the present invention, the substep (C-2) of stretching a film in the TD direction is a step of stretching the film in the TD direction in an oven after step (C-1). In substep (C-1), the film is fixed so that substantially no tension is applied in the width direction (TD direction) and is transported. Heating the film in the oven causes shrinkage of the film to a certain extent. After the looseness of the film disappears because of shrinkage, the film is stretched in the TD direction. The amount of stretching (for the sake of convenience, also referred to as the “expansion rate”) preferably satisfies the expression below, wherein Z (reference numeral 11 in FIG. 1) is the width between fixed ends in the TD direction before stretching of the film, and W (reference numeral 12 in FIG. 1) is the width between fixed ends after the film is stretched in the TD direction.
40.0≧(W−Z)/Z×100>0.00 (expression 4)

If the value (W×Z)/Z×100 (for the sake of convenience, also referred to as “TD expansion ratio”) exceeds the above range, it may become difficult to control the molecular orientation axis of the film in the MD direction. The value (W×Z)/Z×100 is more preferably 30.0≧(W×Z)/Z×100>0.00, and most preferably 20.0≧(W×Z)/Z×100>0.00.

In the substep (C-2), the film is stretched in the TD direction while the distance between the fixed ends of the film is gradually increased. Furthermore, as required, after the substep (C-2), the film may further shrink, and the film width may be further increased. Preferably, the amount of shrinkage and the amount of expansion are selected appropriately.

For a polyimide film having satisfactory heat resistance, the temperature in the substep (C-2) is preferably set at 300° C. to 500° C. and particularly preferably 350° C. to 480° C., because the modulus of elasticity of the polyimide film is reduced, and thus the film is easily stretched. At the above temperature, in some cases, the film is softened and reaches the limit of elongation. In this case, it is preferable to appropriately set a temperature other than the above range.

Furthermore, in the substep (C-2), by adjusting the TD expansion ratio, it is possible to reduce the degree of orientation of the film while the film has orientation in the MD direction. That is, in the substep (C-2), by stretching the film, it is possible to desirably control the degree of orientation of the film.

In the present invention, by adjusting shrinkage in the substep (C-1), stretching in the substep (C-2), tension applied to the film in the MD direction during transportation, the residual component weight in the gel film, and heating temperature, a film having orientation controlled in the MD direction is produced. When the synthetic resin film is a polyimide film, a film-heating temperature and time are completely different whether chemical imidization or thermal imidization is performed. Even when thermal imidization is performed, the control according to the present invention results in a target film.

An oven suitably used in the present invention is a hot-air oven in which hot air having a temperature of 60° C. or more is discharged from the upper surface side, the lower surface side, or both sides with reference to the film, toward the entire film to heat; or a far-infrared oven including a far-infrared ray generator for baking the film with far-infrared rays. In the heating step, it is preferable to bake by a stepwise increase in temperature. For that purpose, a stepwise oven, in which several oven units are connected, is preferably used, the oven units being constituted of hot-air oven units, far-infrared oven units, or both oven units.

In the heating step of the present invention, for the production process of a polyimide film, the initial heating temperature of the film being fixed and transported into the oven is preferably set at 300° C. or less, more preferably 60° C. to 250° C., and most preferably 100° C. to 200° C., from the standpoint that a synthetic resin film having orientation controlled in the MD direction is easily produced. Specifically, when the film is transported into an oven having two or more oven units, the temperature of a first oven unit (reference numeral 2 shown in FIG. 1) is preferably set at 300° C. or less. For the other synthetic resin film, the temperature is preferably determined in view of the type of the synthetic resin film and the volatile temperature of the solvent. In particular, the boiling point of the solvent in the gel film is checked, and it is desirable to set the temperature no higher than 100° C. above the boiling point of the solvent.

In the production of a polyimide film, when the initial heating temperature of the film transported into a first oven unit is set at 300° C. or more, the bowing phenomenon (phenomenon in which strong molecular orientation occurs at the ends of the film because the center of the film is transported into the oven prior to the ends of the film by the influence of shrinkage of the film) occurs, and thus there is a tendency to be difficult to control the molecular orientation axis at the ends of the film in the MD direction. In baking a polyimide film, the temperature in a second oven unit (reference numeral 3 shown in FIG. 1) is preferably set in a range of the temperature in the first oven unit (reference numeral 2 shown in FIG. 1) plus 50° C. to the temperature in the first oven unit plus 300° C. Particularly preferably, the temperature is set in a range of the temperature in the first oven unit plus 60° C. to the temperature in the first oven unit plus 250° C., in order to control the molecular orientation axis of the polyimide film in the MD direction. With respect to the temperature in the subsequent oven units, it is preferable to bake the film at typical temperatures for producing polyimide films. However, when the temperature in the first oven unit (reference numeral 2 shown in FIG. 1) is 60° C. or less, the temperature in the subsequent oven unit (reference numeral 3 shown in FIG. 1) is preferably set at 100° C. to 250° C. By setting the temperature in the second oven unit at the above temperature when the temperature in the first oven unit (reference numeral 2 shown in FIG. 1) is 60° C. or less, it is possible to produce a polyimide film having a molecular orientation axis controlled. Furthermore, the initial temperature and the temperature in the second oven unit are preferably set as described above. With respect to the temperatures other than those temperatures, it is preferable to bake the film at typical temperatures for producing polyimide films. For example, a process in which a polyimide film is stepwise baked at a maximum temperature of 600° C. and gradually cooled to room temperature can be employed. When the maximum baking temperature is low, in some cases, imidization is not completed; hence, satisfactory baking is required.

The tension applied to the gel film in the MD direction when the gel film is transported into the oven is determined by calculating tension (load) applied per meter of the film and is preferably 1 to 20 kg/m, more preferably 1 to 15 kg/m, and most preferably 1 to 10 kg/m. When the tension is 1 kg/m or less, it is difficult to stably transport the film and it tends to be difficult to stably produce the film while the ends are fixed. In addition, when the tension applied to the film is 20 kg/m or more, in particular, it is difficult to control molecular orientation in the MD direction at the ends of the film. Furthermore, the degree of orientation at the ends of the film is higher than that at the center of the film, and there is a tendency to be difficult to uniformly control the degree of orientation across the full width. Examples of a tension generator for applying tension to the gel film to be transported into the oven include a load roller for applying a load to the gel film, a roller for changing a load by adjusting the rotational speed of the roller, and a nip roller set for controlling the tension by pinching the gel film with two rollers. The tension applied to the gel film can be adjusted by such various processes.

Preferably, the tension applied to the film is appropriately adjusted within the above range depending on the thickness of the polyimide film. The thickness of the film is preferably 1 to 200 μm and particularly preferably 1 to 100 μm, from the standpoint of formation of the polyimide film. In the film having a thickness of 200 μm or more, shrinkage stress occurring in the film becomes large, and even when the method according to the present invention is employed, the degree of orientation of the polyimide film cannot be controlled in the MD direction, in some cases, which is undesirable.

By employing the production process according to the present invention, it is possible to obtain a synthetic resin film having molecular orientation in the MD direction. Whether or not the molecules are oriented in the MD direction can be confirmed using a molecular orientation analyzer. With respect to the molecular orientation of a film obtained by the production process according to the present invention, when the orientation of the film is measured using a molecular orientation analyzer MOA2012A manufactured by Oji Scientific Instruments, the molecular orientation angle is preferably 0°±25° or less. The molecular orientation angle of 0° means that a molecular orientation axis corresponds with the MD direction (machine direction of the film). Controlling the molecular orientation axis within the above range results in improvement of modulus of elasticity in the MD direction and a reduction in the coefficient of linear expansion, thus enhancing dimensional stability of the polyimide film. Exceeding the above angle range causes an increase in the coefficient of linear expansion of the film in an oblique direction and a reduction in the modulus of elasticity in the same direction. Therefore, when such a film is used in a step of laminating a metal foil under heating, a change in dimensions in an oblique direction (before and after patterning and heating FPC) is increased. Thus, exceeding the above angle range is not preferable.

Furthermore, by employing the production process according to the present invention, it is possible to obtain a synthetic resin film having molecular orientation in the MD direction across the full width. The state in which the molecules are oriented in the MD direction across the full width of the film is defined as follows. As shown in FIG. 3, for a film having a width of 800 mm or more, at least seven samples including both ends are taken from the film at regular intervals in the width direction. For a film having a width of less than 800 mm, at least five samples including both ends are taken at regular intervals. Strictly speaking, in this process, the measurement is not performed across the full width. However, when all taken samples each have a molecular orientation angle of 0°±25° or less, the film is assumed to have a molecular orientation angle of 0°±25° or less across the full width and to be in the above-described state.

A synthetic resin film according to the present invention may include at least one polymeric layer formed on one surface or both surfaces of a synthetic resin film obtained by a production process according to the present invention, the polymeric layer being formed by application. The polymeric layer is composed of, for example, a thermoplastic polyimide, a polyester, a polyolefin, a polyamide, a polyvinylidene chloride, or an acrylic polymer and may be laminated directly or with, for example, an adhesive layer therebetween. For a polyimide film, the following process may be employed: a solution for forming a thermoplastic polyimide layer (solution containing the thermoplastic polyimide resin or a polyamic acid that is a precursor of the thermoplastic polyimide resin) and a solution for forming a heat-resistant polyimide layer (solution containing a polyamic acid that is a precursor of a heat-resistant polyimide resin) are applied onto a surface of the support at the same time through at least one slit to produce a gel film, and the resulting gel film is baked.

Furthermore, in the method for producing a synthetic resin film according to the present invention, a polymeric resin solution may be flow-cast and applied onto the support so as to form a single or a plurality of layers simultaneously or sequentially, thus producing a synthetic resin film laminate. For a polyimide film, after a gel film composed of a polyamide is produced, the polyimide film may be produced by immersing the gel film in a polyamic acid solution or an imide solution; or by applying a polyamic acid solution or a polyimide solution onto a surface of the gel film using a coater, and then baking the resulting gel film.

A synthetic resin film obtained by a production process according to the present invention may be subjected to any processing, for example, heat treatment, forming, surface treatment, lamination, coating, printing, embossing, or etching, as required.

A synthetic resin film obtained by a production process according to the present invention is particularly suitably used as, but is not limited to, a flexible printed circuit board; or a substrate for use in an electronic and electric apparatus, for example, a tape substrate for TAB or a base film for a high-density recording medium. Furthermore, the synthetic resin film is particularly suitably used for a magnetic recording medium or electrical insulation.

While the present invention will be described specifically based on the examples below, it is to be understood that the present invention is not limited to thereto. In particular, in the present invention, examples of a method for producing a polyimide film will be described.

### EXAMPLE

### Measurement of Modulus of Elasticity

Modulus of elasticity was measured at the center of a produced film in the MD direction (film-transporting direction) and the TD direction (perpendicular to the MD direction) according to JIS C2318 6.3.3 using AUTOGRAPH (model AGS-J, manufactured by Shimadzu Corporation). From the measurements of modulus of elasticity in the MD direction and the TD direction, modulus of elasticity of the film was determined by the following expression.
Modulus of elasticity of film={(modulus of elasticity in MD direction)+(modulus of elasticity in the TD direction)}/2 (expression 5)
(Measurement of Degree of Orientation and Orientation Angle)

As shown in FIG. 3, for a film having a width of 800 mm or more, at least seven samples including both ends were taken from the film at regular intervals in the width direction. For a film having a width of less than 800 mm, at least five samples including both ends were taken at regular intervals. The samples were examined using a microwave molecular orientation analyzer Model MOA2012A manufactured by Oji Scientific Instruments, and the degree of orientation and the orientation angle of the film was determined.

### Example 1

In this example, 50 mol % of 4,4′-diaminodiphenyl ether (ODA), 50 mol % of p-phenylenediamine (p-PDA), 50 mol % of p-phenylenebis(trimellitic acid monoester anhydride) (TMHQ), and 50 mol % of pyromellitic dianhydride (PMDA) were fed into N,N′-dimethylformamide (DMF) in that order. Polymerization was performed to prepare a polyamic acid solution. To the resulting polyamic acid solution, 2.0 equivalents of acetic anhydride and 1.0 equivalent of isoquinoline were added, based on amic acid equivalent. The resulting solution was cast onto an endless belt to form a solution layer having a width of 1,100 mm and a thickness that would yield a thickness of 20 μm after baking. The cast solution was dried at 100° C. to 150° C. using hot air to produce a self-supporting gel film having a residual component ratio of 54 percent by weight. Then, the gel film was stripped from the belt. The gel film was transported into a tentering oven and baked while a tension of 8 kg/m was applied to the gel film in the MD direction. In this example, the film was baked by passing through a hot-air oven unit set at 175° C. (hereinafter, also referred to as “175° C. oven unit”), a hot-air oven unit set at 325° C. (hereinafter, also referred to as “325° C. oven unit”), a hot-air oven unit set at 450° C. (hereinafter, also referred to as “450° C. oven unit”), and a far-infrared oven unit set at 510° C. (hereinafter, also referred to as “510° C. far-infrared oven unit).

Both ends of the gel film in the TD direction were fixed on pin seats without looseness, the distance between the pin seats being 1,000 mm. While the gel film was being transferred, the distance between the fixed ends at the entrance of the oven was set to 956 mm (gel film width: 1,000 mm), the distance between the fixed ends between the 175° C. oven unit and the 325° C. oven unit was set to 956 mm, the distance between the fixed ends between the 325° C. oven unit and the 450° C. oven unit was set to 956 mm, the distance between the fixed ends at the exit of the 510° C. far-infrared oven unit was set to 956 mm, and the distance between the fixed ends at the exit of the oven was set to 956 mm. A polyimide film was formed thereby. While the resulting polyimide film was released and wound, the ends were cut to obtain a film having a width of 940 mm. The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width. The modulus of elasticity of the resulting polyimide film was 6.0 GPa.

### Example 2

The same polyamic acid solution as in EXAMPLE 1 and the same amounts of acetic anhydride and isoquinoline as in EXAMPLE 1 were mixed. The resulting solution was cast onto an endless belt to form a solution layer having a width of 1,100 mm and a thickness that would yield a thickness of 20 μm after baking. The cast solution was dried at 100° C. to 150° C. using hot air to produce a self-supporting gel film having a residual component ratio of 54 percent by weight. Then, the gel film was stripped from the belt. The gel film was transported into a tentering oven and baked while 8 kg/m of tension was applied to the gel film in the MD direction. In this example, the film was baked by passing through a hot-air oven unit set at 190° C. (hereinafter, also referred to as “190° C. oven unit”), a hot-air oven unit set at 400° C. (hereinafter, also referred to as “400° C. oven unit”), a hot-air oven unit set at 450° C., and a far-infrared oven unit set at 510° C. Both ends of the gel film in the TD direction were fixed on pin seats without looseness, the distance between the pin seats being 1,000 mm. While the gel film was being transferred, the distance between the fixed ends at the entrance of the oven was set to 956 mm (gel film width: 1,000 mm), the distance between the fixed ends between the 190° C. oven unit and the 400° C. oven unit was set to 956 mm, the distance between the fixed ends between the 400° C. oven unit and the 450° C. oven unit was set to 956 mm, the distance between the fixed ends at the exit of the 510° C. far-infrared oven unit was set to 956 mm, and the distance between the fixed ends at the exit of the oven was set to 956 mm. A polyimide film was formed thereby. While the resulting polyimide film was released and wound, the ends were cut to obtain a film having a width of 940 mm. The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width. The modulus of elasticity of the resulting polyimide film was 6.0 GPa.

### Example 3

The same polyamic acid solution as in EXAMPLE 1 and the same amounts of acetic anhydride and isoquinoline as in EXAMPLE 1 were mixed. The resulting solution was cast onto an endless belt to form a solution layer having a width of 820 mm and a thickness that would yield a thickness of 20 μm after baking. The cast solution was dried at 100° C. to 120° C. using hot air to produce a self-supporting gel film having a residual component ratio of 60 percent by weight. Then, the gel film was stripped from the belt. The gel film was transported into a tentering oven and baked while 2 kg/m of tension was applied to the gel film in the MD direction. In this example, the film was baked by passing through a hot-air oven unit set at 130° C. (hereinafter, also referred to as “130° C. oven unit”), a hot-air oven unit set at 260° C. (hereinafter, also referred to as “260° C. oven unit”), a hot-air oven unit set at 360° C. (hereinafter, also referred to as “360° C. oven unit”), a hot-air oven unit set at 450° C., and a far-infrared oven unit set at 515° C. (hereinafter, also referred to as “515° C. far-infrared oven unit”). Both ends of the gel film in the TD direction were fixed on pin seats without looseness, the distance between the pin seats being 800 mm. While the gel film was being transferred, the distance between the fixed ends at the entrance of the oven was set to 769 mm (gel film width: 800 mm), the distance between the fixed ends between the 130° C. oven unit and the 260° C. oven unit was set to 769 mm, the distance between the fixed ends between the 260° C. oven unit and the 360° C. oven unit was set to 769 mm, the distance between the fixed ends between the 360° C. oven unit and the 450° C. oven unit was set to 769 mm, the distance between the fixed ends at the exit of the 515° C. far-infrared oven unit was set to 769 mm, and the distance between the fixed ends at the exit of the oven was set to 769 mm. A polyimide film was formed thereby. While the resulting polyimide film was released and wound, the ends were cut to obtain a film having a width of 740 mm. The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width. The modulus of elasticity of the resulting polyimide film was 6.1 GPa.

### Example 4

The same polyamic acid solution as in EXAMPLE 1 and the same amounts of acetic anhydride and isoquinoline as in EXAMPLE 1 were mixed. The resulting solution was cast onto an endless belt to form a solution layer having a width of 850 mm and a thickness that would yield a thickness of 20 μm after baking. The cast solution was dried at 100° C. to 120° C. using hot air to produce a self-supporting gel film having a residual component ratio of 60 percent by weight. Then, the gel film was stripped from the belt. The gel film was transported into a tentering oven and baked while 2 kg/m of tension was applied to the gel film in the MD direction. In this example, the film was baked by passing through a hot-air oven unit set at 130° C., a hot-air oven unit set at 260° C., a hot-air oven unit set at 360° C., a hot-air oven unit set at 450° C., and a far-infrared oven unit set at 515° C. Both ends of the gel film in the TD direction were fixed on pin seats without looseness, the distance between the pin seats being 820 mm. While the gel film was being transferred, the distance between the fixed ends at the entrance of the oven was set to 765 mm (gel film width: 820 mm), the distance between the fixed ends between the 130° C. oven unit and the 260° C. oven unit was set to 765 mm, the distance between the fixed ends between the 260° C. oven unit and the 360° C. oven unit was set to 765 mm, the distance between the fixed ends between the 360° C. oven unit and the 450° C. oven unit was set to 765 mm, the distance between the fixed ends at the exit of the 515° C. far-infrared oven unit was set to 765 mm, and the distance between the fixed ends at the exit of the oven was set to 765 mm. A polyimide film was formed thereby. While the resulting polyimide film was released and wound, the ends were cut to obtain a film having a width of 740 mm. The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width. The modulus of elasticity of the resulting polyimide film was 6.1 GPa.

### Example 5

The same polyamic acid solution as in EXAMPLE 1 and the same amounts of acetic anhydride and isoquinoline as in EXAMPLE 1 were mixed. The resulting solution was cast onto an endless belt to form a solution layer having a width of 1,100 mm and a thickness that would yield a thickness of 20 μm after baking. The cast solution was dried at 100° C. to 150° C. using hot air to produce a self-supporting gel film having a residual component ratio of 54 percent by weight. Then, the gel film was stripped from the belt. The gel film was transported into a tentering oven and baked while 4 kg/m of tension was applied to the gel film in the MD direction. In this example, the film was baked by passing through a hot-air oven unit set at 160° C., a hot-air oven unit set at 300° C., a hot-air oven unit set at 400° C., and a far-infrared oven unit set at 510° C. Both ends of the gel film in the TD direction were fixed on pin seats without looseness, the distance between the pin seats being 1,000 mm. While the gel film was being transferred, the distance between the fixed ends at the entrance of the oven was set to 970 mm (gel film width: 1,000 mm), the distance between the fixed ends between the 160° C. oven unit and the 300° C. oven unit was set to 970 mm, the distance between the fixed ends between the 300° C. oven unit and the 400° C. oven unit was set to 970 mm, the distance between the fixed ends at the exit of the 510° C. far-infrared oven unit was set to 970 mm, and the distance between the fixed ends at the exit of the oven was set to 970 mm. A polyimide film was formed thereby. While the resulting polyimide film was released and wound, the ends were cut to obtain a film having a width of 940 mm. The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width. The modulus of elasticity of the resulting polyimide film was 5.9 GPa.

### Example 6

The same polyamic acid solution as in EXAMPLE 1 and the same amounts of acetic anhydride and isoquinoline as in EXAMPLE 1 were mixed. The resulting solution was cast onto an endless belt to form a solution layer having a width of 1,100 mm and a thickness that would yield a thickness of 20 μm after baking. The cast solution was dried at 100° C. to 150° C. using hot air to produce a self-supporting gel film having a residual component ratio of 54 percent by weight. Then, the gel film was stripped from the belt. The gel film was transported into a tentering oven and baked while 5 kg/m of tension was applied to the gel film in the MD direction. In this example, the film was baked by passing through a hot-air oven unit set at 160° C. (hereinafter, also referred to as “160° C. oven unit”), a hot-air oven unit set at 300° C., a hot-air oven unit set at 400° C., and a far-infrared oven unit set at 510° C. Both ends of the gel film in the TD direction were fixed on pin seats without looseness, the distance between the pin seats being 1,000 mm. While the gel film was being transferred, the distance between the fixed ends at the entrance of the oven was set to 960 mm (gel film width: 1,000 mm), the distance between the fixed ends between the 160° C. oven unit and the 300° C. oven unit was set to 960 mm, the distance between the fixed ends between the 300° C. oven unit and the 400° C. oven unit was set to 960 mm, the distance between the fixed ends at the exit of the 510° C. far-infrared oven unit was set to 960 mm, and the distance between the fixed ends at the exit of the oven was set to 960 mm. A polyimide film was formed thereby. While the resulting polyimide film was released and wound, the ends were cut to obtain a film having a width of 940 mm. The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width. The modulus of elasticity of the resulting polyimide film was 5.9 GPa.

### Example 7

The same polyamic acid solution as in EXAMPLE 1 and the same amounts of acetic anhydride and isoquinoline as in EXAMPLE 1 were mixed. The resulting solution was cast onto an endless belt to form a solution layer having a width of 1,100 mm and a thickness that would yield a thickness of 20 μm after baking. The cast solution was dried at 100° C. to 150° C. using hot air to produce a self-supporting gel film having a residual component ratio of 54 percent by weight. Then, the gel film was stripped from the belt. The gel film was transported into a tentering oven and baked while 6 kg/m of tension was applied to the gel film in the MD direction. In this example, the film was baked by passing through a hot-air oven unit set at 160° C., a hot-air oven unit set at 300° C., a hot-air oven unit set at 400° C., and a far-infrared oven unit set at 510° C. Both ends of the gel film in the TD direction were fixed on pin seats without looseness, the distance between the pin seats being 1,000 mm. While the gel film was being transferred, the distance between the fixed ends at the entrance of the oven was set to 960 mm (gel film width: 1,000 mm), the distance between the fixed ends between the 160° C. oven unit and the 300° C. oven unit was set to 960 mm, the distance between the fixed ends between the 300° C. oven unit and the 400° C. oven unit was set to 960 mm, the distance between the fixed ends at the exit of the 510° C. far-infrared oven unit was set to 960 mm, and the distance between the fixed ends at the exit of the oven was set to 960 mm. A polyimide film was formed thereby. While the resulting polyimide film was released and wound, the ends were cut to obtain a film having a width of 940 mm. The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width. The modulus of elasticity of the resulting polyimide film was 5.9 GPa.

### Example 8

The same polyamic acid solution as in EXAMPLE 1 and the same amounts of acetic anhydride and isoquinoline as in EXAMPLE 1 were mixed. The resulting solution was cast onto an endless belt to form a solution layer having a width of 1,100 mm and a thickness that would yield a thickness of 20 μm after baking. The cast solution was dried at 100° C. to 150° C. using hot air to produce a self-supporting gel film having a residual component ratio of 54 percent by weight. Then, the gel film was stripped from the belt. The gel film was transported into a tentering oven and baked while 8 kg/m of tension was applied to the gel film in the MD direction. In this example, the film was baked by passing through a hot-air oven unit set at 160° C., a hot-air oven unit set at 300° C., a hot-air oven unit set at 400° C., and a far-infrared oven unit set at 510° C. Both ends of the gel film in the TD direction were fixed on pin seats without looseness, the distance between the pin seats being 1,000 mm. While the gel film was being transferred, the distance between the fixed ends at the entrance of the oven was set to 960 mm (gel film width: 1,000 mm), the distance between the fixed ends between the 160° C. oven unit and the 300° C. oven unit was set to 960 mm, the distance between the fixed ends between the 300° C. oven unit and the 400° C. oven unit was set to 960 mm, the distance between the fixed ends at the exit of the 510° C. far-infrared oven unit was set to 960 mm, and the distance between the fixed ends at the exit of the oven was set to 960 mm. A polyimide film was formed thereby. While the resulting polyimide film was released and wound, the ends were cut to obtain a film having a width of 940 mm. The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width. The modulus of elasticity of the resulting polyimide film was 6.0 GPa.

### Example 9

In this example, 75 mol % of 4,4′-diaminodiphenyl ether (ODA), 25 mol % of p-phenylenediamine (p-PDA), and 100 mol % of pyromellitic dianhydride (PMDA) were fed into N,N′-dimethylformamide (DMF) in that order. Polymerization was performed to prepare a polyamic acid solution. To the resulting polyamic acid solution, 2.0 equivalents of acetic anhydride and 1.0 equivalent of isoquinoline were added, based on amic acid equivalent. The resulting solution was cast onto an endless belt to form a solution layer having a width of 1,100 mm and a thickness that would yield a thickness of 20 μm after baking. The cast solution was dried at 100° C. to 150° C. using hot air to produce a self-supporting gel film having a residual component ratio of 54 percent by weight. Then, the gel film was stripped from the belt. The gel film was transported into a tentering oven and baked while 8 kg/m of tension was applied to the gel film in the MD direction. In this example, the film was baked by passing through a hot-air oven unit set at 175° C., a hot-air oven unit set at 325° C., a hot-air oven unit set at 450° C., and a far-infrared oven unit set at 510° C. Both ends of the gel film in the TD direction were fixed on pin seats without looseness, the distance between the pin seats being 1,000 mm. While the gel film was being transferred, the distance between the fixed ends at the entrance of the oven was set to 956 mm (gel film width: 1,000 mm), the distance between the fixed ends between the 175° C. oven unit and the 325° C. oven unit was set to 956 mm, the distance between the fixed ends between the 325° C. oven unit and the 450° C. oven unit was set to 956 mm, the distance between the fixed ends at the exit of the 510° C. far-infrared oven unit was set to 956 mm, and the distance between the fixed ends at the exit of the oven was set to 956 mm. A polyimide film was formed thereby. While the resulting polyimide film was released and wound, the ends were cut to obtain a film having a width of 940 mm. The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width. The modulus of elasticity of the resulting polyimide film was 4.2 GPa. Even when the type of polyimide film is changed, it is possible to produce a polyimide film having orientation in the MD direction as long as the polyimide film has a modulus of elasticity of 4.0 GPa or more.

### Example 10

In this example, 45 mol % of 4,4′-diaminodiphenyl ether (ODA), 55 mol % of p-phenylenediamine (p-PDA), 80 mol % of pyromellitic dianhydride (PMDA), and 20 mol % of 3,3′,4,4′-biphenyltetracarboxylic dianhydride were fed into N,N′-dimethylformamide (DMF) in that order. Polymerization was performed to prepare a polyamic acid solution. To the resulting polyamic acid solution, 2.0 equivalents of acetic anhydride and 1.0 equivalent of isoquinoline were added, based on amic acid equivalent. The resulting solution was cast onto an endless belt to form a solution layer having a width of 1,100 mm and a thickness that would yield a thickness of 20 μm after baking. The cast solution was dried at 100° C. to 150° C. using hot air to produce a self-supporting gel film having a residual component ratio of 54 percent by weight. Then, the gel film was stripped from the belt. The gel film was transported into a tentering oven and baked while 8 kg/m of tension was applied to the gel film in the MD direction. In this example, the film was baked by passing through a hot-air oven unit set at 175° C., a hot-air oven unit set at 325° C., a hot-air oven unit set at 450° C., and a far-infrared oven unit set at 510° C. Both ends of the gel film in the TD direction were fixed on pin seats without looseness, the distance between the pin seats being 1,000 mm. While the gel film was being transferred, the distance between the fixed ends at the entrance of the oven was set to 956 mm (gel film width: 1,000 mm), the distance between the fixed ends between the 175° C. oven unit and the 325° C. oven unit was set to 956 mm, the distance between the fixed ends between the 325° C. oven unit and the 450° C. oven unit was set to 956 mm, the distance between the fixed ends at the exit of the 510° C. far-infrared oven unit was set to 956 mm, and the distance between the fixed ends at the exit of the oven was set to 956 mm. A polyimide film was formed thereby. While the resulting polyimide film was released and wound, the ends were cut to obtain a film having a width of 940 rm. The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width. The modulus of elasticity of the resulting polyimide film was 5.5 GPa. Even when the type of polyimide film is changed, it is possible to produce a polyimide film having orientation in the MD direction as long as the polyimide film has a modulus of elasticity of 4.0 GPa or more.

### Example 11

The same polyamic acid solution as in EXAMPLE 1 and the same amounts of acetic anhydride and isoquinoline as in EXAMPLE 1 were mixed. The resulting solution was cast onto an endless belt to form a solution layer having a width of 1,100 mm and a thickness that would yield a thickness of 20 μm after baking. The cast solution was dried at 100° C. to 140° C. using hot air to produce a self-supporting gel film having a residual component ratio of 28 percent by weight. Then, the gel film was stripped from the belt. The gel film was transported into a tentering oven and baked while 8 kg/m of tension was applied to the gel film in the MD direction. With respect to the baking conditions, the film was baked by passing through a hot-air oven unit set at 175° C., a hot-air oven unit set at 325° C., a hot-air oven unit set at 450° C., and a far-infrared oven unit set at 510° C.

Both ends of the gel film in the TD direction were fixed on pin seats without looseness, the distance between the pin seats being 1,000 mm. While the gel film was being transferred, the distance between the fixed ends at the entrance of the oven was set to 956 mm (gel film width: 1,000 mm), the distance between the fixed ends between the 175° C. oven unit and the 325° C. oven unit was set to 956 mm, the distance between the fixed ends between the 325° C. oven unit and the 450° C. oven unit was set to 956 mm, the distance between the fixed ends at the exit of the 510° C. far-infrared oven unit was set to 956 mm, and the distance between the fixed ends at the exit of the oven was set to 956 mm. A polyimide film was formed thereby. While the resulting polyimide film was released and wound, the ends were cut to obtain a film having a width of 940 mm. The orientation angle and the degree of orientation of the polyimide film thus obtained were measured. Tables 1 and 2 show the experimental results. The modulus of elasticity of the resulting polyimide film was 6.2 GPa.

### Example 12

The same polyamic acid solution as in EXAMPLE 1 and the same amounts of acetic anhydride and isoquinoline as in EXAMPLE 1 were mixed. The resulting solution was cast onto an endless belt to form a solution layer having a width of 1,100 mm and a thickness that would yield a thickness of 20 μm after baking. The cast solution was dried at 100° C. to 120° C. using hot air to produce a self-supporting gel film having a residual component ratio of 107 percent by weight. Then, the gel film was stripped from the belt. The gel film was transported into a tentering oven and baked while 3 kg/m of tension was applied to the gel film in the MD direction. With respect to the baking conditions, the film was baked by passing through a hot-air oven unit set at 175° C., a hot-air oven unit set at 325° C., a hot-air oven unit set at 450° C., and a far-infrared oven unit set at 510° C.

Both ends of the gel film in the TD direction were fixed on pin seats without looseness, the distance between the pin seats being 1,000 mm. While the gel film was being transferred, the distance between the fixed ends at the entrance of the oven was set to 956 mm (gel film width: 1,000 mm), the distance between the fixed ends between the 175° C. oven unit and the 325° C. oven unit was set to 956 mm, the distance between the fixed ends between the 325° C. oven unit and the 450° C. oven unit was set to 956 mm, the distance between the fixed ends at the exit of the 510° C. far-infrared oven unit was set to 956 mm, and the distance between the fixed ends at the exit of the oven was set to 956 mm. A polyimide film was formed thereby. While the resulting polyimide film was released and wound, the ends were cut to obtain a film having a width of 940 mm. The orientation angle and the degree of orientation of the polyimide film thus obtained were measured. Tables 1 and 2 show the experimental results. The modulus of elasticity of the resulting polyimide film was 5.8 GPa.

### Example 13

The same polyamic acid solution as in EXAMPLE 1 and the same amounts of acetic anhydride and isoquinoline as in EXAMPLE 1 were mixed. The resulting solution was cast onto an endless belt to form a solution layer having a width of 900 mm and a thickness that would yield a thickness of 20 μm after baking. The cast solution was dried at 100° C. to 120° C. using hot air to produce a self-supporting gel film having a residual component ratio of 60 percent by weight. Then, the gel film was stripped from the belt. The gel film was transported into a tentering oven and baked while 2 kg/m of tension was applied to the gel film in the MD direction. In this example, the film was baked by passing through a hot-air oven unit set at 130° C., a hot-air oven unit set at 260° C., a hot-air oven unit set at 360° C., a hot-air oven unit set at 450° C., and a far-infrared oven unit set at 515° C. Both ends of the gel film in the TD direction were fixed on pin seats in a loosened state, the distance between the pin seats being 820 mm, the gel film width being 860 mm. While the gel film was being transferred, the distance between the fixed ends at the entrance of the oven was set to 820 mm, the distance between the fixed ends between the 130° C. oven unit and the 260° C. oven unit was set to 820 mm, the distance between the fixed ends between the 260° C. oven unit and the 360° C. oven unit was set to 820 mm, the distance between the fixed ends between the 360° C. oven unit and the 450° C. oven unit was set to 820 mm, the distance between the fixed ends at the exit of the 515° C. far-infrared oven unit was set to 820 mm, and the distance between the fixed ends at the exit of the oven was set to 820 mm. A polyimide film was formed thereby. While the resulting polyimide film was released and wound, the ends were cut to obtain a film having a width of 740 mm. The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width. The modulus of elasticity of the resulting polyimide film was 6.0 GPa.

### Example 14

In this example, 30 mol % of 2,2-bis[4-(4-aminophenoxy)phenyl]propane (BAPP) and 20 mol % of 4,4′-diaminodiphenyl ether (ODA) were dissolved in N,N-dimethylformamide (DMF). To the resulting solution, 20 mol % of 3,3′,4,4′-biphenyltetracarboxylic dianhydride was added and dissolved, and then 35 mol % of pyromellitic dianhydride (PMDA) was added and dissolved. To the resulting solution, 50 mol % of p-phenylenediamine (p-PDA) and 45 mol % of pyromellitic dianhydride (PMDA) were added in that order. Polymerization was performed to prepare a polyamic acid solution. To the resulting polyamic acid solution, 2.3 equivalents of acetic anhydride and 0.5 equivalent of isoquinoline were added, based on amic acid equivalent. The resulting solution was cast onto an endless belt to form a solution layer having a width of 820 mm and a thickness that would yield a thickness of 20 μm after baking. The cast solution was dried at 100° C. to 130° C. using hot air to produce a self-supporting gel film having a residual component ratio of 75 percent by weight. Then, the gel film was stripped from the belt. The gel film was transported into a tentering oven and baked while 6 kg/m of tension was applied to the gel film in the MD direction. Both ends of the gel film in the width direction were fixed on pin seats without looseness, the distance between the pin seats being 800 mm (gel film width: 800 mm). The gel film was stepwise baked at 130° C. (hot-air oven unit), 260° C. (hot-air oven unit), 360° C. (hot-air oven unit), 450° C. (hot-air oven unit), and 515° C. (far-infrared oven unit) to prepare a polyimide film. The polyimide film was transported while the film was loosened and/or stretched in the TD direction so that the TD shrinkage ratio was 3.9 and the TD expansion ratio was 0.0. The step of reducing the distance between the both fixed ends in the TD direction starts from the positions where the gel film was fixed on the pin seats, and completed at the entrance of the oven unit set at 130° C. While the resulting polyimide film was released and wound, the ends were cut to obtain a film having a width of 740 mm. The modulus of elasticity of the resulting polyimide film was 6.7 GPa.

The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width.

### Example 15

In this example, 50 mol % of 4,4′-diaminodiphenyl ether (ODA), 50 mol % of p-phenylenediamine (p-PDA), 50 mol % of p-phenylenebis(trimellitic acid monoester anhydride) (TMHQ), and 50 mol % of pyromellitic dianhydride (PMDA) were fed into N,N′-dimethylformamide (DMF) in that order. Polymerization was performed to prepare a polyamic acid solution. To the resulting polyamic acid solution, 2.0 equivalents of acetic anhydride and 1.0 equivalent of isoquinoline were added, based on amic acid equivalent. The resulting solution was cast onto an endless belt to form a solution layer having a width of 820 mm and a thickness that would yield a thickness of 20 μm after baking. The cast solution was dried at 100° C. to 130° C. using hot air to produce a self-supporting gel film having a residual component ratio of 60 percent by weight. Then, the gel film was stripped from the belt. The gel film was transported into a tentering oven and baked while 2 kg/m of tension was applied to the gel film in the MD direction. Both ends of the gel film in the TD direction were fixed on pin seats without looseness, the distance between the pin seats being 800 mm (gel film width: 800 mm). The gel film was stepwise baked at 130° C. (hot-air oven unit), 260° C. (hot-air oven unit), 360° C. (hot-air oven unit), 450° C. (hot-air oven unit), and 515° C. (far-infrared oven unit) to prepare a polyimide film. The polyimide film was transported while the film was loosened and/or stretched in the TD direction so that the TD shrinkage ratio was 3.9 and the TD expansion ratio was 4.1. The step of reducing the distance between the both fixed ends in the TD direction starts from the positions where the gel film was fixed on the pin seats, and completed at the entrance of the oven unit set at 130° C. The step of stretching the distance between the both fixed ends in the TD direction starts at the entrance of the oven unit set at 450° C., and completed at the exit of the oven unit set at 450° C. While the resulting polyimide film was released and wound, the ends were cut to obtain a film having a width of 740 mm. The modulus of elasticity of the resulting polyimide film was 6.1 GPa.

The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width.

### Example 16

A polyimide film was produced as in EXAMPLE 15 except that the TD shrinkage ratio was 2.0 and the TD expansion ratio was 4.0. While the resulting polyimide film was released and wound, the ends were cut to obtain a film having a width of 740 mm. The modulus of elasticity of the resulting polyimide film was 6.0 GPa.

The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width.

### Example 17

To the same polyamic acid solution as in EXAMPLE 15, 2.0 equivalents of acetic anhydride and 1.0 equivalent of isoquinoline were added, based on amic acid equivalent. The resulting solution was cast onto an endless belt to form a solution layer having a width of 1,200 mm and a thickness that would yield a thickness of 20 μm after baking. The cast solution was dried at 100° C. to 140° C. using hot air to produce a self-supporting gel film having a residual component ratio of 54 percent by weight. Then, the gel film was stripped from the belt. The gel film was transported into a tentering oven and baked while 8 kg/m of tension was applied to the gel film in the MD direction. Both ends of the gel film in the TD direction were fixed on pin seats without looseness, the distance between the pin seats being 1,100 mm (gel film width: 1,100 mm). The gel film was stepwise baked at 175° C. (hot-air oven unit), 300° C. (hot-air oven unit), 450° C. (hot-air oven unit), and 515° C. (far-infrared oven unit) to prepare a polyimide film. The polyimide film was transported while the film was loosened and/or stretched in the TD direction so that the TD shrinkage ratio was 4.4 and the TD expansion ratio was 2.3. The step of reducing the distance between the both fixed ends in the TD direction starts from the positions where the gel film was fixed on the pin seats, and completed at the entrance of the oven unit set at 175° C. The step of stretching the distance between the both fixed ends in the TD direction starts at the entrance of the oven unit set at 450° C., and completed at the exit of the oven unit set at 450° C. While the resulting polyimide film was released and wound, the ends were cut to obtain a film having a width of 940 mm.

The orientation angle and the degree of orientation of the polyimide film thus obtained were measured. Tables 1 and 2 show the experimental results. The modulus of elasticity of the resulting polyimide film was 6.0 GPa. As a result of the measurement of the molecular orientation axis, it was found that it was possible to produce the polyimide film having molecular orientation controlled in the MD direction and having an angle of molecular orientation axis in a range of 0°±25° across the full width.

### Example 18

A polyimide film was produced as in EXAMPLE 17 except that the TD shrinkage ratio was 4.4 and the TD expansion ratio was 4.6. While the resulting polyimide film was released and wound, the ends were cut to obtain a film having a width of 940 mm. The modulus of elasticity of the resulting polyimide film was 5.9 GPa.

The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width.

### Example 19

To the same polyamic acid solution as in EXAMPLE 14, 2.0 equivalents of acetic anhydride and 1.0 equivalent of isoquinoline were added, based on amic acid equivalent. The resulting solution was cast onto an endless belt to form a solution layer having a width of 1,200 mm and a thickness that would yield a thickness of 20 μm after baking. The cast solution was dried at 100° C. to 140° C. using hot air to produce a self-supporting gel film having a residual component ratio of 62 percent by weight. Then, the gel film was stripped from the belt. The gel film was transported into a tentering oven and baked while 3.5 kg/m of tension was applied to the gel film in the MD direction. Both ends of the gel film in the TD direction were fixed on pin seats without looseness, the distance between the pin seats being 1,100 mm (gel film width: 1,100 mm). The gel film was stepwise baked at 165° C. (hot-air oven unit), 300° C. (hot-air oven unit), 400° C. (hot-air oven unit), and 515° C. (far-infrared oven unit) to prepare a polyimide film. The polyimide film was transported while the film was loosened and/or stretched in the TD direction so that the TD shrinkage ratio was 4.0 and the TD expansion ratio was 2.1. The step of reducing the distance between the both fixed ends in the TD direction starts from the positions where the gel film was fixed on the pin seats, and completed at the entrance of the oven unit set at 165° C. The step of stretching the distance between the both fixed ends in the TD direction starts at the entrance of the oven unit set at 400° C., and completed at the exit of the oven unit set at 400° C. While the resulting polyimide film was released and wound, the ends were cut to obtain a film having a width of 940 mm.

The orientation angle and the degree of orientation of the polyimide film thus obtained were measured. The modulus of elasticity of the resulting polyimide film was 6.0 GPa. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width.

### Example 20

In this example, 75 mol % of 4,4′-diaminodiphenyl ether (ODA), 25 mol % of p-phenylenediamine (p-PDA), and 100 mol % of pyromellitic dianhydride (PMDA) were fed into N,N′-dimethylformamide (DMF) in that order. Polymerization was performed to prepare a polyamic acid solution. To the resulting polyamic acid solution, 2.0 equivalents of acetic anhydride and 1.0 equivalent of isoquinoline were added, based on amic acid equivalent. The resulting solution was cast onto an endless belt to form a solution layer having a width of 820 mm and a thickness that would yield a thickness of 20 μm after baking. The cast solution was dried at 100° C. to 150° C. using hot air to produce a self-supporting gel film having a residual component ratio of 60 percent by weight. The gel film was stripped and transported into a tentering oven and baked while 2 kg/m of tension was applied to the gel film in the MD direction. Both ends of the gel film in the TD direction were fixed on pin seats without looseness, the distance between the pin seats being 800 mm (gel film width: 800 mm). The gel film was stepwise baked at 130° C. (hot-air oven unit), 260° C. (hot-air oven unit), 360° C. (hot-air oven unit), 450° C. (hot-air oven unit), and 515° C. (far-infrared oven unit) to prepare a polyimide film. The polyimide film was transported while the film was loosened and/or stretched in the TD direction so that the TD shrinkage ratio was 3.9 and the TD expansion ratio was 4.1. The step of reducing the distance between the both fixed ends in the TD direction starts from the positions where the gel film was fixed on the pin seats, and completed at the entrance of the oven unit set at 130° C. The step of stretching the distance between the both fixed ends in the TD direction starts at the entrance of the oven unit set at 450° C., and completed at the exit of the oven unit set at 450° C. While the resulting polyimide film was released and wound, the ends were cut to obtain a film having a width of 740 mm. The modulus of elasticity of the resulting polyimide film was 4.2 GPa.

The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width. Even when the type of polyimide film is changed, it is possible to produce a polyimide film having orientation in the MD direction as long as the polyimide film has a modulus of elasticity of 4.0 GPa or more.

### Example 21

In this example, 45 mol % of 4,4′-diaminodiphenyl ether (ODA), 55 mol % of p-phenylenediamine (p-PDA), 80 mol % of pyromellitic dianhydride (PMDA), and 20 mol % of 3,3′,4,4′-biphenyltetracarboxylic were added to N,N-dimethylformamide (DMF), in that order. Polymerization was performed to prepare a polyamic acid solution. To the resulting polyamic acid solution, 2.0 equivalents of acetic anhydride and 1.0 equivalent of isoquinoline were added, based on amic acid equivalent. The resulting solution was cast onto an endless belt to form a solution layer having a width of 820 mm and a thickness that would yield a thickness of 20 μm after baking. The cast solution was dried at 100° C. to 150° C. using hot air to produce a self-supporting gel film having a residual component ratio of 60 percent by weight. Then, the gel film was stripped from the belt. The gel film was transported into a tentering oven and baked while 2 kg/m of tension was applied to the gel film in the MD direction. Both ends of the gel film in the width direction were fixed on pin seats without looseness, the distance between the pin seats being 800 mm (gel film width: 800 mm). The gel film was stepwise baked at 130° C. (hot-air oven unit), 260° C. (hot-air oven unit), 360° C. (hot-air oven unit), 450° C. (hot-air oven unit), and 450° C. (far-infrared oven unit) to prepare a polyimide film. The polyimide film was transported while the film was loosened and/or stretched in the TD direction so that the TD shrinkage ratio was 3.9 and the TD expansion ratio was 4.1. The step of reducing the distance between the both fixed ends in the TD direction starts from the positions where the gel film was fixed on the pin seats, and completed at the entrance of the oven unit set at 130° C. The step of stretching the distance between the both fixed ends in the TD direction starts at the entrance of the oven unit set at 450° C. (hot-air oven unit), and completed at the exit of the oven unit set at 450° C. (hot-air oven unit). While the resulting polyimide film was released and wound, the ends were cut to obtain a film having a width of 740 mm. The modulus of elasticity of the resulting polyimide film was 5.5 GPa.

The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width. Even when the type of polyimide film is changed, it is possible to produce a polyimide film having orientation in the MD direction as long as the polyimide film has a modulus of elasticity of 4.0 GPa or more.

### Example 22

In this example, 30 mol % of 2,2-bis[4-(4-aminophenoxy)phenyl]propane (BAPP) and 20 mol % of 4,4′-diaminodiphenyl ether (ODA) were dissolved in N,N-dimethylformamide (DMF). To the resulting solution, 20 mol % of 3,3′,4,4′-biphenyltetracarboxylic dianhydride was added and dissolved, and then 35 mol % of pyromellitic dianhydride (PMDA) was added and dissolved. To the resulting solution, 50 mol % of p-phenylenediamine (p-PDA) and 45 mol % of pyromellitic dianhydride (PMDA) were added in that order. Polymerization was performed to prepare a polyamic acid solution. To the resulting polyamic acid solution, 2.3 equivalents of acetic anhydride and 0.5 equivalent of isoquinoline were added, based on amic acid equivalent. The resulting solution was cast onto an endless belt to form a solution layer having a width of 820 mm and a thickness that would yield a thickness of 20 μm after baking. The cast solution was dried at 100° C. to 130° C. using hot air to produce a self-supporting gel film having a residual component ratio of 75 percent by weight. Then, the gel film was stripped from the belt. The gel film was transported into a tentering oven and baked while 6 kg/m of tension was applied to the gel film in the MD direction. Both ends of the gel film in the width direction were fixed on pin seats without looseness, the distance between the pin seats being 800 mm (gel film width: 800 mm). The gel film was stepwise baked at 130° C. (hot-air oven unit), 260° C. (hot-air oven unit), 360° C. (hot-air oven unit), 450° C. (hot-air oven unit), and 515° C. (far-infrared oven unit) to prepare a polyimide film. The polyimide film was transported while the film was loosened and/or stretched in the TD direction so that the TD shrinkage ratio was 3.9 and the TD expansion ratio was 4.0. The step of reducing the distance between the both fixed ends in the TD direction starts from the positions where the gel film was fixed on the pin seats, and completed at the entrance of the oven unit set at 130° C. The step of stretching the distance between the both fixed ends in the TD direction starts at the entrance of the oven unit set at 450° C., and completed at the exit of the oven unit set at 450° C. While the resulting polyimide film was released and wound, the ends were cut to obtain a film having a width of 740 mm. The modulus of elasticity of the resulting polyimide film was 6.7 GPa.

The orientation angle and the degree of orientation of the polyimide film thus obtained were measured. Tables 1 and 2 show the experimental results. As a result of the measurement of the molecular orientation axis, it was found that it was possible to produce the polyimide film having molecular orientation controlled in the MD direction and having an angle of molecular orientation axis in a range of 0°±25° across the full width.

### Comparative Example 1

The same polyamic acid solution as in EXAMPLE 1 and the same amounts of acetic anhydride and isoquinoline as in EXAMPLE 1 were mixed. The resulting solution was cast onto an endless belt to form a solution layer having a width of 1,100 mm and a thickness that would yield a thickness of 20 μm after baking. The cast solution was dried at 100° C. to 140° C. using hot air to produce a self-supporting gel film having a residual component ratio of 54 percent by weight. Then, the gel film was stripped from the belt. The gel film was transported into a tentering oven and baked while 8 kg/m of tension was applied to the gel film in the MD direction. In this example, the film was baked by passing through a hot-air oven unit set at 350° C., a hot-air oven unit set at 400° C., a hot-air oven unit set at 450° C., and a far-infrared oven unit set at 515° C. Both ends of the gel film in the TD direction were fixed on pin seats without looseness, the distance between the pin seats being 1,000 mm. While the gel film was being transferred, the distance between the fixed ends at the entrance of the oven was set to 1,000 mm (gel film width: 1,000 mm), the distance between the fixed ends between the 350° C. oven unit and the 400° C. oven unit was set to 1,000 mm, the distance between the fixed ends between the 400° C. oven unit and the 450° C. oven unit was set to 1,000 mm, the distance between the fixed ends at the exit of the 515° C. far-infrared oven unit was set to 1,000 mm, and the distance between the fixed ends at the exit of the oven was set to 1,000 mm. A polyimide film was formed thereby. While the resulting polyimide film was released and wound, the ends were cut to obtain a film having a width of 940 mm. The orientation angle and the degree of orientation of the polyimide film thus obtained were measured. Tables 1 and 2 show the experimental results.

### Comparative Example 2

The same polyamic acid solution as in EXAMPLE 1 and the same amounts of acetic anhydride and isoquinoline as in EXAMPLE 1 were mixed. The resulting solution was cast onto an endless belt to form a solution layer having a width of 820 mm and a thickness that would yield a thickness of 20 μm after baking. The cast solution was dried at 100° C. to 130° C. using hot air to produce a self-supporting gel film having a residual component ratio of 60 percent by weight. Then, the gel film was stripped from the belt. The gel film was transported into a tentering oven and baked while 2 kg/m of tension was applied to the gel film in the MD direction. In this example, the film was baked by passing through a hot-air oven unit set at 130° C., a hot-air oven unit set at 260° C., a hot-air oven unit set at 360° C., a hot-air oven unit set at 450° C., and a far-infrared oven unit set at 515° C. Both ends of the gel film in the TD direction were fixed on pin seats without looseness, the distance between the pin seats being 800 mm. While the gel film was being transferred, the distance between the fixed ends at the entrance of the oven was set to 800 mm (gel film width: 800 mm), the distance between the fixed ends between the 130° C. oven unit and the 260° C. oven unit was set to 800 mm, the distance between the fixed ends between the 260° C. oven unit and the 360° C. oven unit was set to 800 mm, the distance between the fixed ends between the 360° C. oven unit and the 450° C. oven unit was set to 800 mm, the distance between the fixed ends at the exit of the 515° C. far-infrared oven unit was set to 800 mm, and the distance between the fixed ends at the exit of the oven was set to 800 mm. A polyimide film was formed thereby. While the resulting polyimide film was released and wound, the ends were cut to obtain a film having a width of 740 mm. The orientation angle and the degree of orientation of the polyimide film thus obtained were measured. Tables 1 and 2 show the experimental results.

### Comparative Example 3

In this example, 100 mol % of 4,4′-diaminodiphenyl ether (ODA) and 100 mol % of pyromellitic dianhydride (PMDA) were fed into N,N′-dimethylformamide (DMF) in that order. Polymerization was performed to prepare a polyamic acid solution. To the resulting polyamic acid solution, 2.0 equivalents of acetic anhydride and 1.0 equivalent of isoquinoline were added, based on amic acid equivalent. The resulting solution was cast onto an endless belt to form a solution layer having a width of 820 mm and a thickness that would yield a thickness of 20 μm after baking. The cast solution was dried at 100° C. to 150° C. using hot air to produce a self-supporting gel film having a residual component ratio of 40 percent by weight. The gel film was stripped and transported into a tentering oven and baked while 2 kg/m of tension was applied to the gel film in the MD direction. Both ends of the gel film in the TD direction were fixed on pin seats without looseness, the distance between the pin seats being 800 mm (gel film width: 800 mm). The gel film was stepwise baked at 130° C. (hot-air oven unit), 260° C. (hot-air oven unit), 360° C. (hot-air oven unit), 450° C. (hot-air oven unit), and 515° C. (far-infrared oven unit) to prepare a polyimide film. The polyimide film was transported while the film was loosened and/or stretched in the TD direction so that the TD shrinkage ratio was 4.0 and the TD expansion ratio was 3.9. The step of reducing the distance between the both fixed ends in the TD direction starts from the positions where the gel film was fixed on the pin seats, and completed at the entrance of the oven unit set at 130° C. The step of stretching the distance between the both fixed ends in the TD direction starts at the entrance of the oven unit set at 450° C., and completed at the exit of the oven unit set at 450° C. While the resulting polyimide film was released and wound, the ends were cut to obtain a film having a width of 740 mm. The modulus of elasticity of the resulting polyimide film was 3.5 GPa.

The orientation angle and the degree of orientation of the polyimide film thus obtained were measured. Tables 1 and 2 show the experimental results.

TABLE 1
Production conditions of polyimide film

| | | | | | Temperature of oven | | | | |
|---|---|---|---|---|---|---|---|---|---|
| | Residual | Tension applied | TD shrinkage | TD | unit/° C. | | | | |
| | component ratio % | to gel film kg/m | rate % | expansion rate (%) | 1 | 2 | 3 | 4 | 5 |
| EXAMPLE 1 | 54 | 8 | 4.4 | 0.0 | 175 | 325 | 450 | 510 | |
| EXAMPLE 2 | 54 | 8 | 4.4 | 0.0 | 190 | 400 | 450 | 510 | |
| EXAMPLE 3 | 60 | 2 | 3.9 | 0.0 | 130 | 260 | 360 | 450 | 515 |
| EXAMPLE 4 | 60 | 2 | 6.7 | 0.0 | 130 | 260 | 360 | 450 | 515 |
| EXAMPLE 5 | 54 | 4 | 3.0 | 0.0 | 160 | 300 | 400 | 515 | |
| EXAMPLE 6 | 54 | 5 | 4.0 | 0.0 | 160 | 300 | 400 | 515 | |
| EXAMPLE 7 | 54 | 6 | 4.0 | 0.0 | 160 | 300 | 400 | 515 | |
| EXAMPLE 8 | 54 | 8 | 4.0 | 0.0 | 160 | 300 | 400 | 515 | |
| EXAMPLE 9 | 54 | 8 | 4.4 | 0.0 | 175 | 325 | 450 | 510 | |
| EXAMPLE 10 | 54 | 8 | 4.4 | 0.0 | 175 | 325 | 450 | 450 | |
| EXAMPLE 11 | 28 | 8 | 4.4 | 0.0 | 175 | 325 | 450 | 510 | |
| EXAMPLE 12 | 107 | 3 | 4.4 | 0.0 | 175 | 325 | 450 | 510 | |
| EXAMPLE 13 | 60 | 2 | 6.7 | 0.0 | 130 | 260 | 360 | 450 | 515 |
| EXAMPLE 14 | 75 | 6 | 3.9 | 0.0 | 130 | 260 | 360 | 450 | 515 |
| EXAMPLE 15 | 60 | 2 | 3.9 | 4.1 | 130 | 260 | 360 | 450 | 515 |
| EXAMPLE 16 | 60 | 2 | 2.0 | 4.0 | 130 | 260 | 360 | 450 | 515 |
| EXAMPLE 17 | 54 | 8 | 4.4 | 2.3 | 175 | 300 | 450 | 515 | |
| EXAMPLE 18 | 54 | 8 | 4.4 | 4.6 | 175 | 300 | 450 | 515 | |
| EXAMPLE 19 | 62 | 3.5 | 4.0 | 2.1 | 165 | 300 | 400 | 515 | |
| EXAMPLE 20 | 60 | 2 | 3.9 | 4.1 | 130 | 260 | 360 | 450 | 515 |
| EXAMPLE 21 | 60 | 2 | 3.9 | 4.1 | 130 | 260 | 360 | 450 | 450 |
| EXAMPLE 22 | 75 | 6 | 3.9 | 4.0 | 130 | 260 | 360 | 450 | 515 |
| COMPARATIVE | 54 | 8 | 0.0 | 0.0 | 350 | 400 | 450 | 510 | |
| EXAMPLE 1 | | | | | | | | | |
| COMPARATIVE | 60 | 2 | 0.0 | 0.0 | 130 | 260 | 360 | 450 | 515 |
| EXAMPLE 2 | | | | | | | | | |
| COMPARATIVE | 40 | 2 | 4.0 | 3.9 | 130 | 260 | 360 | 450 | 515 |
| EXAMPLE 3 | | | | | | | | | |

TABLE 2
Physical properties of polyimide film

| | Angle/Angle | | | | | | | MORc | | | | | | |
|---|---|---|---|---|---|---|---|---|---|---|---|---|---|---|
| | Measured position | | | | | | | Measured position/mm | | | | | | |
| | A | B | C | D | E | F | G | A | B | C | D | E | F | G |
| EXAMPLE 1 | −3 | −2 | −7 | −6 | −6 | −6 | 11 | 1.42 | 1.58 | 1.66 | 1.70 | 1.66 | 1.57 | 1.43 |
| EXAMPLE 2 | −16 | −2 | −1 | −6 | −7 | −1 | 18 | 1.44 | 1.57 | 1.6 | 1.65 | 1.59 | 1.6 | 1.42 |
| EXAMPLE 3 | −1 | −2 | 0 | 3 | 5 | | | 1.55 | 1.50 | 1.48 | 1.53 | 1.66 | | |
| EXAMPLE 4 | −6 | −2 | 1 | 2 | 5 | | | 2.13 | 1.97 | 1.90 | 1.90 | 1.94 | | |
| EXAMPLE 5 | −17 | −3 | −2 | −8 | −9 | −11 | −2 | 1.44 | 1.44 | 1.45 | 1.32 | 1.58 | 1.67 | 1.46 |
| EXAMPLE 6 | −9 | −1 | 1 | −6 | −10 | −7 | −2 | 1.55 | 1.62 | 1.57 | 1.50 | 1.75 | 1.74 | 1.60 |
| EXAMPLE 7 | −9 | −4 | −7 | −6 | −9 | −7 | 3 | 1.70 | 1.74 | 1.59 | 1.60 | 1.71 | 1.74 | 1.65 |
| EXAMPLE 8 | −17 | −8 | −8 | −8 | −6 | −7 | 1 | 1.61 | 1.63 | 1.58 | 1.60 | 1.77 | 1.85 | 1.70 |
| EXAMPLE 9 | −2 | 1 | 3 | 4 | 5 | −1 | −3 | 1.34 | 1.22 | 1.18 | 1.23 | 1.22 | 1.33 | 1.34 |
| EXAMPLE 10 | −8 | −5 | −7 | −6 | −4 | −6 | 9 | 1.5 | 1.67 | 1.59 | 1.59 | 1.65 | 1.66 | 1.7 |
| EXAMPLE 11 | −24 | −17 | −6 | −1 | 4 | 15 | 20 | 1.8 | 1.58 | 1.52 | 1.55 | 1.7 | 1.65 | 1.85 |
| EXAMPLE 12 | −3 | 2 | 2 | 4 | 3 | −5 | −6 | 1.62 | 1.66 | 1.56 | 1.5 | 1.7 | 1.68 | 1.65 |
| EXAMPLE 13 | −10 | −5 | 5 | 3 | 10 | | | 2.13 | 1.97 | 1.9 | 1.9 | 1.94 | | |
| EXAMPLE 14 | −3 | 0 | 4 | −13 | 13 | | | 1.32 | 1.27 | 1.32 | 1.18 | 1.35 | | |
| EXAMPLE 15 | −4 | 0 | −3 | −2 | −1 | | | 1.53 | 1.39 | 1.38 | 1.48 | 1.48 | | |
| EXAMPLE 16 | 0 | 9 | −8 | 7 | 19 | | | 1.30 | 1.12 | 1.13 | 1.24 | 1.32 | | |
| EXAMPLE 17 | 0 | −4 | −5 | −3 | −4 | −1 | 6 | 1.54 | 1.43 | 1.55 | 1.49 | 1.56 | 1.45 | 1.43 |
| EXAMPLE 18 | −5 | −8 | 10 | −1 | −1 | 2 | 10 | 1.55 | 1.29 | 1.31 | 1.25 | 1.37 | 1.35 | 1.36 |
| EXAMPLE 19 | −15 | 0 | −8 | −13 | −9 | −8 | 2 | 1.61 | 1.44 | 1.38 | 1.63 | 1.66 | 1.62 | 1.5 |
| EXAMPLE 20 | 5 | 8 | −8 | 2 | 10 | | | 1.24 | 1.18 | 1.2 | 1.15 | 1.18 | | |
| EXAMPLE 21 | 5 | 4 | −1 | −3 | 6 | | | 1.44 | 1.35 | 1.42 | 1.48 | 1.39 | | |
| EXAMPLE 22 | −9 | 3 | 0 | 11 | 9 | | | 1.16 | 1.18 | 1.18 | 1.19 | 1.14 | | |
| COMPARATIVE EXAMPLE 1 | −44 | −35 | −60 | 90 | 28 | 22 | 45 | 1.97 | 1.26 | 1.17 | 1.21 | 1.3 | 1.24 | 2.47 |
| COMPARATIVE EXAMPLE 2 | −19 | 64 | 58 | 39 | 37 | | | 1.35 | 1.05 | 1.17 | 1.26 | 1.47 | | |
| COMPARATIVE EXAMPLE 3 | −40 | −52 | 89 | 89 | 46 | | | 1.12 | 1.18 | 1.09 | 1.12 | 1.15 | | |

1. A method for continuously producing a synthetic resin film comprising at least the following steps (A) to (C):
(A) a step of continuously flow-casting and applying a composition containing a polymer and an organic solvent onto a support to form a gel film;
(B) a step of stripping the gel film from the support and fixing both ends of the gel film; and
(C) a step of transporting the film with both ends being fixed in an oven, wherein step (C) comprises at least a substep (C-1) of transporting the film with both ends being fixed so that substantially no tension is applied in the width direction (transverse direction (TD direction)) of the film.

2. The method for producing the synthetic resin film according to claim 1, wherein, in step (C), both ends are fixed so that substantially no tension is applied in the TD direction at an entrance of the oven.

3. The method for producing the synthetic resin film according to claim 2, wherein the oven comprises at least two oven units and a temperature of a first oven unit is set at 300° C. or less.

4. The method for producing the synthetic resin film according to claim 1, wherein, in step (C), both ends are fixed so that the distance X between the fixed ends and the width Y of the film between the fixed ends satisfy the following formula:
20.0≧(Y−X)/Y×100>0.00

5. The method for producing the synthetic resin film according to claim 1, wherein
in step (C) both ends are fixed so that substantially no tension is applied in the TD direction at an entrance of the oven, and
the oven comprises at least two oven units and a temperature of a first oven unit is set at 300° C. or less, and
in step (C), both ends are fixed so that the distance X between the fixed ends and the width Y of the film between the fixed ends satisfy the following formula:
20.0≧(Y−X)/Y×100>0.00

6. The method for producing the synthetic resin film according to claim 1, wherein step (C) comprises a substep (C-2) of stretching the film in the TD direction.

7. The method for producing the synthetic resin film according to claim 6, wherein, in substep (C-2), the film is stretched in the TD direction so that the distance Z between the fixed ends in the TD direction before the film is stretched and the distance W between the fixed ends after the film stretched satisfy the following formula:
40.0≧(W−Z)/Z×100>0.00

8. The method for producing the synthetic resin film according to claim 1, wherein:
in step (C) both ends are fixed so that substantially no tension is applied in the TD direction at an entrance of the oven, and
in step (C) both ends are fixed so that the distance X between the fixed ends and the width Y of the film between the fixed ends satisfy the following formula:
20.0≧(Y−X)/Y×100>0.00, and
step (C) comprises a substep (C-2) of stretching the film in the TD direction, and
in substep (C-2), the film is stretched in the TD direction so that the distance Z between the fixed ends in the TD direction before the film is stretched and the distance W between the fixed ends after the film stretched satisfy the following formula:
40.0≧(W−Z)/Z×100>0.00.

9. The method for producing the synthetic resin film according to claim 1, wherein:
in step (C), both ends are fixed so that substantially no tension is applied in the TD direction at an entrance of the oven, and
the oven comprises at least two oven units and a temperature of a first oven unit is set at 300° C. or less, and
in step (C), both ends are fixed so that the distance X between the fixed ends and the width Y of the film between the fixed ends satisfy the following formula:
20.0≧(Y−X)/Y×100>0.00, and
step (C) comprises a substep (C-2) of stretching the film in the TD direction, and
in substep (C-2), the film is stretched in the TD direction so that the distance Z between the fixed ends in the TD direction before the film is stretched and the distance W between the fixed ends after the film stretched satisfy the following formula:
40.0≧(W−Z)/Z×100>0.00.

10. The method for producing the synthetic resin film according to claim 1, wherein the synthetic resin film is a polyimide film.

11. The method for producing the synthetic resin film according to claim 1, wherein:
in step (C), both ends are fixed so that substantially no tension is applied in the TD direction at an entrance of the oven, and
the synthetic resin film is a polyimide film.

12. The method for producing the synthetic resin film according to claims 1, wherein:
in step (C), both ends are fixed so that substantially no tension is applied in the TD direction at an entrance of the oven, and
the oven comprises at least two oven units and a temperature of a first oven unit is set at 300° C. or less, and
the synthetic resin film is a polyimide film.

13. The method for producing the synthetic resin film according to claim 1, wherein:
in step (C), both ends are fixed so that the distance X between the fixed ends and the width Y of the film between the fixed ends satisfy the following formula:
20.0≧(Y−X)/Y×100>0.00, and
the synthetic resin film is a polyimide film.

14. The method for producing the synthetic resin film according to claim 1, wherein:
in step (C), both ends are fixed so that substantially no tension is applied in the TD direction at an entrance of the oven, and
the oven comprises at least two oven units and a temperature of a first oven unit is set at 300° C. or less, and
in step (C), both ends are fixed so that the distance X between the fixed ends and the width Y of the film between the fixed ends satisfy the following formula:
20.0≧(Y−X)/Y×100>0.00, and
the synthetic resin film is a polyimide film.

15. The method for producing the synthetic resin film according to claims 1, wherein:
step (C) comprises a substep (C-2) of stretching the film in the TD direction, and
the synthetic resin film is a polyimide film.

16. The method for producing the synthetic resin film according to claim 1, wherein:
in step (C), both ends are fixed so that substantially no tension is applied in the TD direction at an entrance of the oven, and
the oven comprises at least two oven units and a temperature of a first oven unit is set at 300° C. or less, and
in step (C), both ends are fixed so that the distance X between the fixed ends and the width Y of the film between the fixed ends satisfy the following formula:
20.0≧(Y−X)/Y×100>0.00, and
step (C) comprises a substep (C-2) of stretching the film in the TD direction, and
in substep (C-2), the film is stretched in the TD direction so that the distance Z between the fixed ends in the TD direction before the film is stretched and the distance W between the fixed ends after the film stretched satisfy the following formula:
40.0≧(W−Z)/Z×100>0.00, and
the synthetic resin film is a polyimide film

17. The method for producing the synthetic resin film according to claim 1, wherein:
in step (C), both ends are fixed so that substantially no tension is applied in the TD direction at an entrance of the oven, and
in step (C), both ends are fixed so that the distance X between the fixed ends and the width Y of the film between the fixed ends satisfy the following formula:
20.0≧(Y−X)/Y×100>0.00, and
step (C) comprises a substep (C-2) of stretching the film in the TD direction, and
in substep (C-2), the film is stretched in the TD direction so that the distance Z between the fixed ends in the TD direction before the film is stretched and the distance W between the fixed ends after the film stretched satisfy the following formula:
40.0≧(W−Z)/Z×100>0.00, and
the synthetic resin film is a polyimide film

18. A synthetic resin film produced by the method for producing the synthetic resin film according to claim 1.

19. A synthetic resin film produced by the method for producing the synthetic resin film according to claim 1, wherein the synthetic resin film is a polyimide film.

20. A synthetic resin film produced by the method for producing the synthetic resin film according to claim 1, wherein:
in step (C), both ends are fixed so that substantially no tension is applied in the TD direction at an entrance of the oven, and
in step (C), both ends are fixed so that the distance X between the fixed ends and the width Y of the film between the fixed ends satisfy the following formula:
20.0≧(Y−X)/Y×100>0.00, and
step (C) comprises a substep (C-2) of stretching the film in the TD direction, and
in substep (C-2), the film is stretched in the TD direction so that the distance Z between the fixed ends in the TD direction before the film is stretched and the distance W between the fixed ends after the film stretched satisfy the following formula:
40.0≧(W−Z)/Z×100>0.00, and
the synthetic resin film is a polyimide film.
